(19) United States
(12) Patent Application Publication
(10) Pub. No.: US 2026/0304258 A1
(43) Pub. Date: Oct. 1, 2026

(54) Radio Link Control (RLC) Retransmission with L1/L2 Triggered Mobility (LTM) Cell Switch

(71) Applicant: Telefonaktiebolaget LM Ericsson (publ), Stockholm (SE)

(72) Inventors: Pontus Wallentin, Linköping (SE); Erik Eriksson, Linköping (SE); John Christer Skördeman, Linköping (SE); Stefan Wager, Espoo (FI)

(21) Appl. No.: 19/478,621

(22) PCT Filed: Apr. 26, 2024
(86) PCT No.: PCT/SE2024/050403

§ 371 Date: Oct. 24, 2025

Related U.S. Application Data
(60) Provisional application No. 63/501,254, filed on May 10, 2023.

(51) Int. Cl. H04W 36/04; H04L 1/1812; H04W 36/00

(52) U.S. Cl. CPC H04W 36/04; H04L 1/1812; H04W 36/00835

(57) ABSTRACT

Embodiments include methods for a user equipment (UE) configured to communicate with a radio access network (RAN) node. Such methods include receiving, from the RAN node via a serving cell, a lower layer signalling message indicating that the UE should perform an L1/L2-triggered mobility (LTM) procedure from the serving cell to a first candidate cell. Such methods include executing the LTM procedure towards the first candidate cell, including performing a reset of a first protocol layer used for communicating with the serving cell. Such methods include, after executing the LTM procedure, initiating retrans-mission in the first candidate cell of protocol data units (PDUs) of a second protocol layer, which were lost or discarded due to the reset of the first protocol layer. Other embodiments include complementary methods for RAN nodes that provide the serving cell and the first candidate cell.

### TECHNICAL FIELD

The present application relates generally to the field of wireless networks, and more specifically to improving mobility of user equipment (UEs) across multiple cells in a wireless network, specifically mobility based on layer-1 (L1) and/or layer-2 (L2) procedures that incur less delay than conventional layer-3 (L3) mobility procedures.

### INTRODUCTION

Currently the fifth generation (5G) of cellular systems is being standardized within the Third-Generation Partnership Project (3GPP). 5G is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in EPC 198 via respective S1-C interfaces. Similarly, gNBs can connect to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

NG-RAN nodes shown in FIG. 1 include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each of the CUs and DUs can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

LTE Rel-10 introduced support for channel bandwidths larger than 20 MHz. To remain compatible with legacy UEs from earlier releases (e.g., Rel-8), a wideband LTE Rel-10 carrier appears as multiple component carriers (CCs), each having the structure of a Rel-8 carrier. A Rel-10 UE can receive multiple CCs based on Carrier Aggregation (CA). The CCs can be considered “cells”, such that a UE in CA has one primary cell (PCell) and one or more secondary cells (SCells). These are referred to collectively as a “cell group”. NR supports CA starting in Rel-15. As specified in 3GPP document RP-213565, NR Rel-18 includes a Work Item on NR mobility enhancements, including in the technical area of L1/L2 based inter-cell mobility, also referred to as L1/L2 triggered mobility (LTM). When the UE moves between the coverage areas of two cells, a serving cell change needs to be performed at some point. Currently, serving cell change is triggered by layer 3 (L3) measurements and involves radio resource control (RRC) signaling to change PCell and PSCell (e.g., when dual connectivity is configured), as well as release/add SCells (e.g., when CA is configured).

Currently, all inter-cell mobility involves complete layer 2 (L2) and layer 1 (L1, i.e., PHY) resets, leading to longer latency, increased signaling overhead, and longer interruptions than for intra-cell beam switching. Thus, a goal of Rel-18 L1/L2 mobility enhancements is to facilitate serving cell change via L1/L2 signaling to address these problems and/or difficulties. Rel-18 LTM is limited to intra-gNB mobility, including the two cases of intra-DU cell changes and inter-DU/intra-CU cell changes.

### SUMMARY

During L3 handover, MAC is always reset and RLC is always re-established, both of which often cause data loss and/or delay in data delivery. For LTM cell switch, there is an opportunity to reduce data loss relative to L3 handover, especially for the intra-DU case in which Medium Access Control (MAC) and Radio Link Control (RLC) protocol layers for source and target cells are managed by the same DU. When data is lost on MAC layer, it will be recovered by RLC layer retransmission for acknowledged mode (AM) bearers but not for unacknowledged mode (UM) bearers. Even so, RLC retransmission will not happen immediately since there will be some delay until data loss is detected by RLC. Since RLC delivers data in sequence, this RLC retransmission delay will cause a delivery delay not only for the lost data but also for any data that was transmitted after the lost data.

An object of embodiments of the present disclosure is to address these and related problems, issues, and/or difficulties by facilitating UE LTM operations with minimal and/or reduced delay in data delivery.

Some embodiments of the present disclosure include methods (e.g., procedures) for a UE configured to communicate with a RAN node.

These exemplary methods include receiving, from the RAN node via a serving cell, a lower layer signalling message indicating that the UE should perform an LTM procedure from the serving cell to a first candidate cell. These exemplary methods also include executing the LTM procedure towards the first candidate cell, including performing a reset of a first protocol layer used for communicating with the serving cell. These exemplary methods also include, after executing the LTM procedure, initiating retransmission in the first candidate cell of protocol data units (PDUs) of a second protocol layer, which were lost or discarded due to the reset of the first protocol layer.

In some embodiments, the first candidate cell and the serving are provided by the RAN node (e.g., different DUs) or by a same DU of the RAN node. In some embodiments, one or more of the following applies: the first protocol layer is below the second protocol layer, and the lower layer signaling message is a message of the first protocol layer.

In some embodiments, performing the reset of the first protocol layer comprises includes one or more of the following operations:
setting a new data indicator (NDI) for an UL HARQ process to zero;
flushing soft buffers for a downlink (DL) HARQ process; and
considering a next-received transmission of a transport block (TB) as an initial transmission for a DL HARQ process.

In some embodiments, the lost or discarded PDUs of the second protocol layer include uplink (UL) PDUs transmitted via the serving cell. In some of these embodiments, these exemplary methods also include receiving one or more status reports of the second protocol layer. The one or more status reports can be received in the serving cell before executing the LTM procedure or in the first candidate cell after executing the LTM procedure. In these embodiments, initiating retransmission of the UL PDUs is responsive to the one or more status reports.

In some embodiments, the lost or discarded PDUs of the second protocol layer include DL PDUs transmitted via the serving cell. In such embodiments, initiating retransmission of the DL PDUs includes transmitting one or more status reports of the second protocol layer. The one or more status reports can be transmitted in the serving cell before executing the LTM procedure or in the first candidate cell after executing the LTM procedure.

Other embodiments include methods (e.g., procedures) for a RAN node configured to provide a serving cell to UEs.

These exemplary methods include sending, to the UE via the serving cell, a lower layer signalling message indicating that the UE should perform an LTM procedure from the serving cell to a first candidate cell, including UE reset of a first protocol layer used for communicating with the serving cell. These exemplary methods also include initiating retransmission in the first candidate cell of PDUs of a second protocol layer, which were lost or discarded due to the UE reset of the first protocol layer.

In some embodiments, the first candidate cell and the serving cell are provided by the RAN node (e.g., different DUs) or by a same DU of the RAN node. In some embodiments, one or more of the following applies: the first protocol layer is below the second protocol layer, and the lower layer signaling message is a message of the first protocol layer.

In some embodiments, these exemplary methods also include, based on sending the lower layer signaling message, performing a corresponding reset of the first protocol layer used to communicate with the UE via the serving cell, including one or more of the following operations:
setting a new data indicator (NDI) for a DL HARQ process to zero;
flushing soft buffers for an UL HARQ process; and
considering a next-received transmission of a transport block (TB) as an initial transmission for an UL HARQ process.

In some embodiments, the lost or discarded PDUs of the second protocol layer include UL PDUs transmitted via the serving cell. In such embodiments, initiating retransmission of the UL PDUs includes sending to the UE via the serving cell one or more status reports of the second protocol layer. Note that reception of the one or more status reports causes the UE to initiate retransmission of the UL PDUs in the first candidate cell, as summarized above in relation to UE embodiments.

In some embodiments, the lost or discarded PDUs of the second protocol layer include DL PDUs transmitted via the serving cell. In such embodiments, initiating retransmission of the DL PDUs includes sending to the UE via the serving cell one or more of the following indications:
an indication to transmit one or more status reports, of the second protocol layer, in the candidate target cell; and
an indication to stop a timer of the second protocol layer, which when running prevents transmission of status reports of the second protocol layer.

Other embodiments include methods (e.g., procedures) for a RAN node configured to provide a serving cell to UEs.

These exemplary methods include receiving, from a UE, a message indicating that the UE has completed an LTM procedure from a source cell to a serving cell provided by the RAN node. The serving cell is a first candidate cell and the LTM procedure includes UE reset of a first protocol layer used for communicating with the source cell. These exemplary methods also include initiating retransmission in the serving cell of PDUs of a second protocol layer, which were lost or discarded due to the UE reset of the first protocol layer.

In some embodiments, the source cell and the serving cell are provided by the RAN node (e.g., different DUs) or by a same DU of the RAN node. In some embodiments, one or more of the following applies: the first protocol layer is below the second protocol layer, and the lower layer signaling message is a message of the first protocol layer.

In some embodiments, the exemplary method also includes the operations of block 920, where based on the message in block 910, the RAN node performs a corresponding reset of the first protocol layer used to communicate with the UE via the serving cell, including one or more of the following operations labelled with corresponding sub-block numbers:
(921) setting a new data indicator (NDI) for a DL HARQ process to zero;
(922) flushing soft buffers for an UL HARQ process; and
(923) considering a next-received transmission of a transport block (TB) as an initial transmission for an UL HARQ process.

In some embodiments, the lost or discarded PDUs of the second protocol layer include UL PDUs transmitted via the source cell. In such embodiments, initiating retransmission of the UL PDUs includes sending, to the UE via the serving (i.e., first candidate) cell, one or more status reports of the second protocol layer. Note that reception of the one or more status reports causes the UE to initiate retransmission of the UL PDUs in the serving cell, such as described above for UE embodiments.

In some embodiments, the lost or discarded PDUs of the second protocol layer include DL PDUs transmitted via the source cell. In such embodiments, initiating retransmission of the DL PDUs includes receiving from the UE via the serving (i.e., first candidate) cell one or more status reports of the second protocol layer. In some of these embodiments, initiating retransmission of the DL PDUs also includes sending to the UE via the serving cell one or more of the following indications:
an indication to transmit the one or more status reports; and
an indication to stop a timer of the second protocol layer, which when running prevents transmission of status reports of the second protocol layer.

In such embodiments, the one or more status reports are received responsive to the one or more indications.

Other embodiments include UEs (e.g., wireless devices) and RAN nodes (e.g., base stations, eNBs, gNBs, ng-eNBs, etc. or parts thereof such as CU/DU) configured to perform operations corresponding to any of the exemplary methods described herein. Other embodiments also include non-transitory, computer-readable media storing computer-executable instructions that, when executed by processing circuitry, configure such UEs and RAN nodes to perform operations corresponding to any of the exemplary methods described herein.

These and other embodiments described herein can provide various technical benefits and/or advantages. For example, embodiments may enable a UE to execute an LTM cell switch procedure (e.g., intra-DU) that includes HARQ reset but no RLC re-establishment with reduced data interruption. For example, embodiments may reduce retransmission delay for RLC PDUs that are lost due the HARQ reset during LTM cell switch. At a high level, embodiments may improve UE mobility in a RAN.

These and other objects, features, and advantages of the present disclosure will become apparent upon reading the following Detailed Description in view of the Drawings briefly described below.

### BRIEF DESCRIPTION OF THE DRAWINGS

FIG. 1 shows an exemplary 5G/NR network architecture.

FIG. 2 shows exemplary 5G/NR user plane (UP) and control plane (CP) protocol stacks.

FIGS. 3-4 show logical architectures for a gNB arranged in the split CU/DU architecture illustrated by FIG. 1.

FIG. 5 shows an example of RLC retransmission during HARQ reset at LTM cell switch.

FIG. 6 shows a signaling diagram for an intra-DU LTM cell switch procedure, according to some embodiments of the present disclosure.

FIG. 7 shows an exemplary method (e.g., procedure) for a UE, according to various embodiments of the present disclosure.

FIGS. 8-9 show exemplary methods (e.g., procedures) for a RAN node, according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in which functions implemented by some embodiments of the present disclosure may be virtualized.

FIG. 15 illustrates communication between a host computing system, a network node, and a UE via multiple connections, at least one of which is wireless, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them.

FIG. 2 shows an exemplary configuration of NR user plane (UP) and control plane (CP) protocol stacks between a UE (210), a gNB (220), and an AMF (230). Physical (PHY), Medium Access Control (MAC), Radio Link Control (RLC), and Packet Data Convergence Protocol (PDCP) layers between UE and gNB are common to UP and CP. PDCP provides ciphering/deciphering, integrity protection, sequence numbering, reordering, and duplicate detection for both CP and UP, as well as header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (in gNB). PHY provides transport channel services to MAC and manages transfer over the NR radio interface, e.g., via modulation, coding, antenna mapping, and beam forming.

On the CP side, the non-access stratum (NAS) layer between UE and AMF handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC IDLE state until an RRC connection is established with the network, at which time the UE will transition to RRC CONNECTED state (e.g., where data transfer can occur). The UE must perform a random-access (RA) procedure to move from RRC IDLE to RRC CONNECTED state where the cell serving the UE is known and an RRC context is established for the UE in the serving gNB, so UE and gNB can communicate.

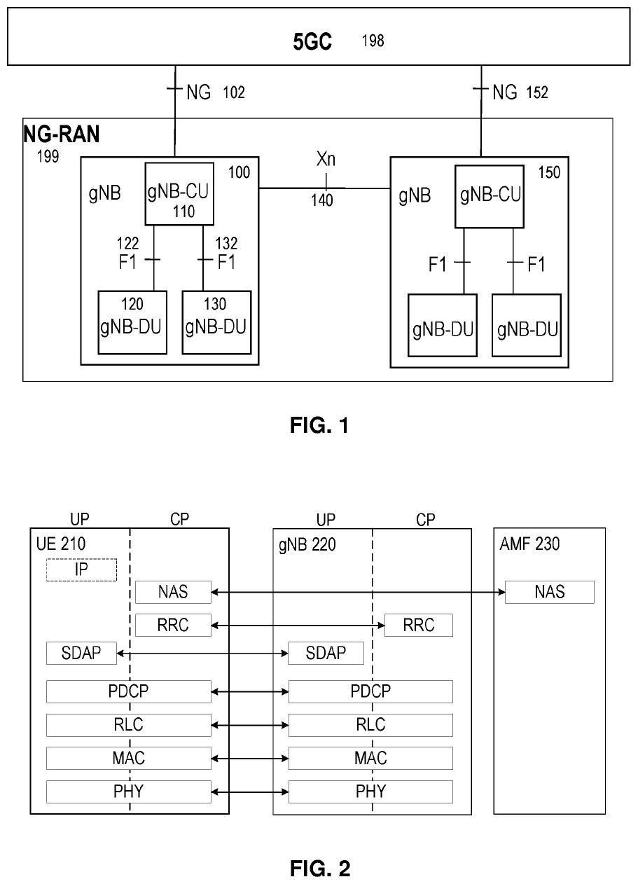

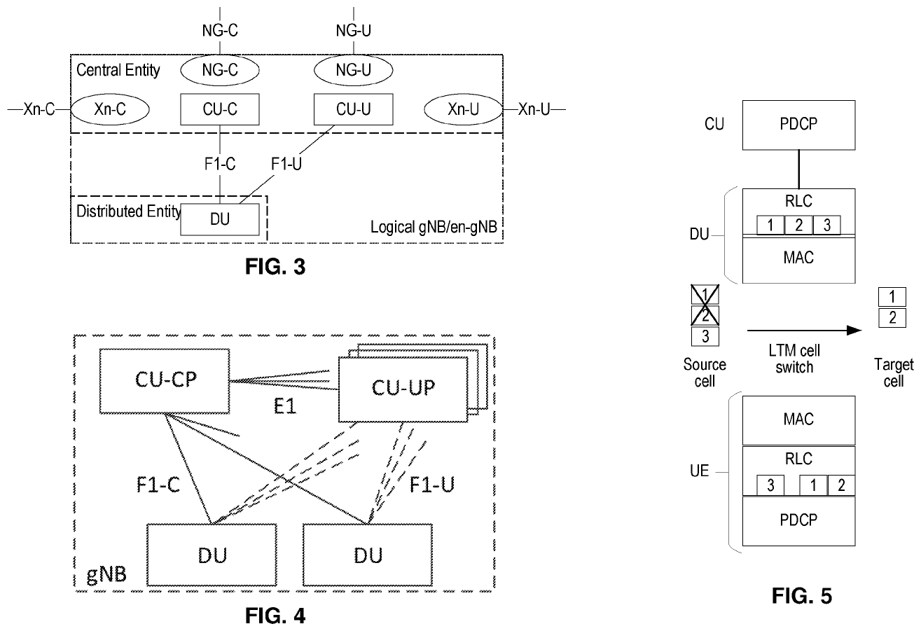

FIG. 3 shows a logical architecture for a gNB arranged in the split CU/DU architecture, such as gNB 100 in FIG. 1. This logical architecture separates the CU into CP and UP functionality, called CU-C and CU-U, respectively. Furthermore, each of the NG, Xn, and F1 interfaces is split into a CP interface (e.g., NG-C) and a UP interface (e.g., NG-U). Note that the terms “Central Entity” and “Distributed Entity” in FIG. 3 refer to physical network nodes.

FIG. 4 shows another exemplary gNB logical architecture that includes two gNB-DUs, a gNB-CU-CP, and multiple gNB-CU-UPs. The gNB-CU-CP may be connected to the gNB-DU through the F1-C interface, and the gNB-CU-UP may be connected to the gNB-DU through the F1-U interface and to the gNB-CU-CP through the E1 interface. Each gNB-DU may be connected to only one gNB-CU-CP, and each gNB-CU-UP may be connected to only one gNB-CU-CP. One gNB-DU may be connected to multiple gNB-CU-UPs under the control of the same gNB-CU-CP. Also, one gNB-CU-UP may be connected to multiple DUs under the control of the same gNB-CU-CP. When referring herein to an operation performed by a “CU”, it should be understood that this operation can be performed by any entities within the CU (e.g., CU-CP, gNB-CU-CP) unless stated otherwise.

NR DL and UL physical resources are organized into equal-sized 1-ms subframes. A subframe is further divided into multiple slots of equal duration, with each slot including multiple OFDM-based symbols. An NR slot can include 14 OFDM symbols for normal cyclic prefix and 12 symbols for extended cyclic prefix. A resource block (RB) consists of a group of 12 contiguous OFDM subcarriers for a duration of a 12- or 14-symbol slot. A resource element (RE) corresponds to one OFDM subcarrier during one OFDM symbol interval. An NR slot can also be arranged with various time-division duplexing (TDD) arrangements of UL and DL symbols.

As briefly mentioned above, in addition to providing coverage via cells as in LTE, NR networks also provide coverage via beams as well as cells. In general, a DL “beam” is a coverage area of a network-transmitted reference signal (RS) that may be measured or monitored by a UE. These RS are carried by various REs within DL RBs, which also carry various DL physical channels such as physical DL control channel (PDCCH), physical DL shared channel (PDSCH), physical broadcast channel (PBCH), etc.

In NR deployments, a cell is identified using one or more SSB beams associated with respective indices, with a maximum number of four for carrier frequency <3 GHz, eight for carrier frequency 3-6 GHz, and 64 in frequency range FR2 (e.g., 24.25-71 GHz). Only one SSB beam is transmitted per cell in each slot. In most cases, RAN nodes use a large numbers of antenna elements to form directional beams that cover narrow ranges of azimuth and elevation in a cell, in a technique often referred to as “beamforming”. For example, each SSB beam is transmitted in a different direction (i.e., different range of azimuth and elevation) than other SSB beams in the cell, with the process of transmitting all SSB beams often referred to as “transmit (or TX) beam sweeping”. Each SSB (or beam carrying it) is associated with an index (or identifier) that indicates the relative order of the SSB in the transmit beam sweeping pattern.

When entering a cell, a UE does not know the location of the serving RAN node and from which direction(s) SSB beam(s) can be received in the cell. Thus, the UE may also beamform its receiving antenna elements to search for SSBs in different directions at different times, a process often referred to as “receive (or RX) beam sweeping”. The number of different directions in which UE searches for SSB is referred to as “RX beam sweeping factor” and depends on UE implementation. Once the UE identifies one or more SSB from RX beam sweeping, the UE may perform measurements on the identified SSB, which may be referred to as “beam measurements”. Currently, various inter-cell UE mobility-related procedures are triggered by UE layer 3 (L3, e.g., RRM) RSRP measurements followed by network RRC signaling. These mobility procedures include changing primary cell (PCell), changing primary secondary cell group (SCG) cell (PSCell), and/or adding or releasing SCGs (when dual connectivity is configured for the UE), as well as adding or releasing secondary cells (SCells, e.g., when carrier aggregation is configured for the UE), etc. The L3 RSRP measurements are configured in the UE based on an RRCReconfiguration message carrying an RRC MeasConfig IE and a MeasIdToAdd IE.

In contrast, L1 RSRP measurements by the UE are needed for beam management, which is also known as intra-cell mobility or RRC-less mobility. Since these L1 and L3 measurements have different purposes and/or requirements (e.g., in terms of accuracy), the UE may perform them at different measurement occasions. Moreover, 3GPP TS 38.133(v 17.8.0 ) specifies that the total number of RSs (e.g., SSBs) on which the UE can perform configured L1-RSRP and L3-RSRP measurements at any given time is restricted due to UE processing limitations. 3GPP Rel-17 includes an inter-cell beam management (ICBM) feature, with a goal of increasing DL data rate by facilitating multi-transmission reception point (TRP) operation. A UE can have multiple active transmission configuration indicator (TCI) states, including one associated with the physical cell identity (PCI) of its serving cell and up to M other TCI states associated with PCIs of other cells. For example, the different PCIs can represent different TRPs. For each of the N additional TCI states, the UE can be configured with CSI resources (or resource sets) to monitor for inter-PCI (or inter-cell) beam management.

As specified in 3GPP document RP-213565, 3 GPP Rel-18 includes a Work Item on NR mobility enhancements, including in the technical area of L1/L2 based inter-cell mobility, also known as L1/L2 triggered mobility (LTM). Conventionally, all inter-cell mobility operations are triggered by L3 RSRP measurements and involve complete layer 2 (L2) and layer 1 (L1, i.e., PHY) resets, leading to longer latency, increased signaling overhead, and longer interruptions than for intra-cell beam switching. Thus, a high-level goal of the Rel-18 L1/L2 mobility enhancements is to facilitate serving cell change via L1/L2 signaling to address these problems and/or difficulties. Some more specific goals include specifying the following:
Configuration and maintenance for multiple candidate cells to allow fast application of configurations for candidate cells;
Dynamic switch mechanism among candidate serving cells (including SpCell and SCell) for the potential applicable scenarios based on L1/L2 signalling;
L1 enhancements for inter-cell beam management, including L1 measurement and reporting, and beam indication;
Timing Advance management; and
CU-DU interface signaling to support L1/L2 mobility, if needed.

These Rel-18 L1/L2 mobility enhancements also consider the split CU/DU architecture shown in FIGS. 1 and 3-4, including for intra-DU and inter-DU/intra-CU cell changes. In the inter-DU/intra-CU scenario, the candidate cell for LTM is a cell served by a neighbor DU to the (serving or source) DU that currently provides the UE's PCell (or PSCell, for SCG change in DC).

In LTM a UE is pre-configured by its serving RAN with one RRC configuration per LTM candidate cell, sometimes referred to as an “LTM candidate cell configuration”. This configuration may be an RRCReconfiguration message or a portion thereof, such as one or more IEs/fields/parameters (e.g., CellGroupConfig IE). The UE performs measurements on these LTM candidate cells and transmits corresponding measurement reports to the RAN, which triggers the execution of a LTM cell switch procedure by the UE to one of the LTM candidate cells. This triggering is done by transmitting an LTM cell switch command to the UE in lower layer signaling (e.g., MAC control element (CE)). Based on this commend, the UE connects to the associated LTM candidate cell and uses the previously received RRC configuration for this LTM candidate cell.

3GPP has made the following agreements on user plane (UP) handling during LTM:
Assume that L2 is continued whenever possible (e.g., intra-DU), without Reset, with the target to avoid data loss and the additional delay of data recovery.
Assume that at L1/L2 cell switch, whether the UE performs partial or full MAC reset (FFS what partial reset is, e.g., to avoid data loss), re-establishes RLC, performs data recovery with PDCP, etc. is explicitly controlled by the network via RRC configuration. For further study (FFS) if MAC CE indication(s) is/are needed.
No consensus to support HARQ continuation and in order to resume discussion some new input may be needed, e.g., quantitative evidence of a serious problem.

During L3 handover, MAC is always reset and RLC is always re-established, both of which often cause data loss and/or delay in data delivery. For LTM cell switch, there is an opportunity to reduce data loss relative to L3 handover, especially for the intra-DU case in which MAC and RLC entities for source and target cells are managed by the same DU. At a minimum, no RLC re-establishment would be necessary and handling of MAC at intra-DU LTM is still under consideration in 3GPP.

It has been suggested that the MAC hybrid ARQ (HARQ) protocol should not be continued even for an intra-DU LTM cell switch, which implies that a UE would perform many of the actions at MAC reset even during intra-DU LTM cell switch procedure. For example, 3GPP TS 38.321 (v17.4.0) section 5.21 specifies the handling of UL/DL HARQ during the MAC reset as follows:

### * * * Begin 3GPP TS 38.321 Text * * *

If a reset of the MAC entity is requested by upper layers or the reset of the MAC entity is triggered due to SCG deactivation as defined in clause 5.29, the MAC entity shall:
1> set the NDIs for all uplink HARQ processes to the value 0;
1> flush the soft buffers for all DL HARQ processes, except for the DL HARQ process being used for MBS broadcast;
1> for each DL HARQ process, consider the next received transmission for a TB as the very first transmission;

### * * * End 3GPP TS 38.321 Text * * *

These “HARQ reset” actions are specified for the UE but the RAN should take corresponding actions, with UL/DL actions being swapped. This HARQ reset will result in some RLC PDUs already submitted to MAC for transmission are lost in the MAC layer. The amount of lost data depends on the HARQ configuration, such as the number of HARQ processes. However, even if the amount of lost data due to each MAC reset is small, the total data loss may be relatively high due to the relatively higher frequency of LTM cell switch compared to L3 handover.

When data is lost on MAC, it will be recovered by RLC retransmission for acknowledged mode (AM) bearers but not for unacknowledged mode (UM) bearers. FIG. 5 shows an example scenario of RLC retransmission during HARQ reset at LTM cell switch. RLC SDUs (service data units, or “segments”) with SN=1, 2, 3 are transmitted from the DU to the UE in a source cell. The RLC SDU with SN=3 is successfully delivered to the UE but RLC SDUs with SNs=1, 2 are lost due to HARQ reset at LTM cell switch from the source cell to the target cell. However, these lost RLC SDUs will be retransmitted in the target cell after LTM cell switch.

Even so, RLC retransmission will not happen immediately since there will be some delay until data loss is detected by RLC. RLC retransmissions by RLC STATUS PDUs (sometimes also referred to as RLC STATUS reports) sent from receiver to transmitter. The transmitter can set a polling bit in an AM Data (AMD) RLC PDU, which will trigger the receiver to respond with an RLC STATUS PDU that includes information about what data has been received. The receiver will also send a RLC STATUS PDU when it detects a gap in received RLC SNs, i.e., indicating missing PDU(s).

When receiving the RLC STATUS report, the transmitter knows exactly which data needs retransmission and thereby avoids retransmitting data that was received already. The interval between polls is controlled by various parameters, including pollPDU parameter and window size. Too frequent RLC STATUS reports may trigger unnecessary retransmissions, e.g., if retransmissions triggered by a previous RLC STATUS report have not yet reached the receiver when a subsequent RLC STATUS report is transmitted.

A t-StatusProhibit timer is configured to address this problem, with a value typically set slightly larger than the RLC round trip time. The t-StatusProhibit timer is started upon transmission of the RLC STATUS report and subsequent RLC STATUS reports are not possible until the timer has expired.

Since RLC delivers data in sequence, RLC retransmission delay will cause a delivery delay not only for the lost data but also for any data that was transmitted after the lost data.

Embodiments of the present disclosure address these and other problems, difficulties, and/or issues by providing flexible and efficient techniques for a UE configured with one or more LTM candidate cells to execute an LTM cell switch procedure, including HARQ reset, to one of the LTM candidate cells, which triggers RLC retransmissions. Other embodiments include complementary techniques for a source RAN node (e.g., DU) to manage data retransmission during LTM cell switch for a UE based on transmitting to the UE an LTM cell switch command that cause HARQ reset for the UE and triggers data retransmission. Other embodiments include complementary techniques for a target RAN node (e.g., DU) to manage data retransmission during LTM cell switch for a UE based on receiving from the UE an LTM cell switch complete message and triggering data retransmission. Note that in the case of intra-DU LTM cell switch, the source RAN node and the target RAN node can be the same DU of a RAN node.

Embodiments can be summarized as follows. Some embodiments include methods for triggering retransmission of UL data, such as by one of the following:
A source DU transmits RLC status report(s), together with LTM cell switch command (or tunnelled via target DU). Based on the received RLC status reports, the UE will then trigger RLC retransmission in the target cell.
In response to performing an LTM cell switch, the UE sets a polling bit in the first RLC AMD PDU(s) transmitted in the target cell. This triggers the target DU to transmit RLC status report(s), based on which the UE will then trigger RLC retransmission in the target cell.
When the UE executes the MAC reset during the LTM cell switch procedure, the UE indicates to RLC layer that the transmission of some RLC PDUs failed (e.g., local NACK), due to being discarded during MAC reset. The UE RLC layer can use this information to trigger retransmission of the UL RLC PDUs. In various embodiments, the indication can include the number of RLC PDUs discarded or the actual RLC SNs of the discarded RLC PDUs. Alternately, the indication can indicate only that RLC PDUs were discarded.

Other embodiments include methods for triggering retransmission of DL data, such as by one of the following:
The source RAN node sets a polling bit in RLC AMD PDUs transmitted to the UE shortly before the LTM cell switch command, or the target RAN node sets a polling bit in RLC AMD PDUs transmitted to the UE after the UE arrives in the target cell. This triggers the UE to transmit an RLC status report to the network, either in source cell or target cell, depending on when the UE receives the polling bit.
In response to receiving the LTM cell switch command, the UE transmits RLC status report(s) to the network, either in source cell or target cell. This polling can be controlled by flags in the LTM cell switch command or be triggered by RRC.
During the LTM cell switch procedure, the UE stops the RLC timer t-StatusProhibit. This RLC layer action can be in response to an indication from the UE RRC layer, from the UE MAC layer, or from the RAN (e.g., source RAN node). This action will cause the UE to transmit RLC status report(s) in the target cell more quickly.

In response to receiving an RLC status report from the UE, triggered in any of the ways listed above, the target RAN node can retransmit DL RLC AMD PDUs to the UE in the target cell.

Other embodiments include techniques for reducing retransmission delay by introducing a special interpretation of a RLC status report, in which any non-acknowledged RLC SN transmitted on a different cell is considered as non-acknowledged in a target cell.

Embodiments of the present disclosure may provide various benefits and/or advantages. For example, embodiments may enable a UE to execute an LTM cell switch procedure (e.g., intra-DU) that includes HARQ reset but no RLC re-establishment with reduced data interruption. For example, embodiments may reduce retransmission delay for RLC PDUs that are lost due the HARQ reset during LTM cell switch. At a high level, embodiments may improve UE mobility in a RAN.

In the present disclosure, the term “LTM candidate cell” refers to a non-serving cell configured for a UE, to which the UE can perform an L1/L2 inter-cell mobility operation upon reception of lower layer signaling instructing the UE to do so. The terms “candidate cell,” “candidate,” “mobility candidate,” “non-serving cell,” and “additional cell” may be used interchangeably with “LTM candidate cell.” A UE may perform and report measurements on (e.g., CSI measurements) on an LTM candidate cell, causing the RAN to decide to which beam (e.g., TCI state) and/or cell the UE should be switched. An LTM candidate cell may be a candidate for a PCell, a PSCell, or an SCell of a cell group (e.g., MCG or SCG).

In the present disclosure, the following terms may be used interchangeably: “L1/L2 based inter-cell mobility” (as used in the 3GPP Work Item), “L1/L2 mobility,” “L1-mobility,” “L1 based mobility,” “L1/L2-centric inter-cell mobility,” “L1/L2 inter-cell mobility,” “inter-cell beam management,” “inter-DU L1/L2 based inter-cell mobility”, and “L1/L2 triggered mobility” (also known as LTM). These terms refer to a scenario in which a UE receives lower layer (i.e., below RRC, such as MAC or PHY) signaling from a network indicating for the UE to change of its serving cell (e.g., PCell) from a source cell to a target cell. The content of the lower layer signaling may be referred to as “LTM cell switch command”. Exemplary lower layer signaling includes L1 DL control information (DCI) and L2 MAC control element (CE). Compared to conventional RRC signaling, lower layer signaling reduces processing time and interruption time during mobility and may also increase mobility robustness since the network can respond more quickly to changes in the UE's channel conditions.

The change of serving cell (e.g., PCell) may also lead to a change in SCell(s) of the same cell group, e.g., in case the command triggers the UE to change to another cell group configuration of the same type (e.g., another MCG configuration). For example, an LTM cell switch may include a change in SpCell (e.g., PCell for MCG, PSCell for SCG) and a change (e.g., addition, modification and/or release) in SCells of the same cell group.

Before the UE receives the LTM cell switch command, the UE is configured by the network with one or more “LTM candidate cell configurations” via an RRCReconfiguration message. The terms “(LTM) candidate configuration”, “LTM configuration”, “(LTM) candidate target cell configuration”, and “(LTM) target candidate (cell) configuration” may be used interchangeably with LTM candidate cell configuration.

An LTM candidate cell configuration may be included in an RRC IE such as CellGroupConfig, SpCellConfig, or SCellConfig and/or an embedded RRCReconfiguration message for an LTM candidate cell. An LTM candidate cell configuration includes configuration parameters the UE needs to operate in that LTM candidate cell when it performs an LTM cell switch procedure, e.g., upon reception of the LTM cell switch command. As some more specific examples, an LTM candidate cell configuration can include a PCell configuration and one or more SCell configurations of an MCG, or a PSCell configuration and one or more SCell configurations of an SCG. The exact content and/or structure of the IE and/or embedded message for an LTM candidate cell configuration may be called “RRC model for the candidate configuration” or more simply “RRC model”.

A UE may receive an LTM candidate cell configuration in complete form or as a delta (or difference) relative to a reference configuration (which may be signalled separately). In the latter case, the actual LTM candidate configuration is a combination of the delta configuration and the reference configuration.

The lower layer signaling from the RAN may include an identifier (or index) associated with an LTM candidate cell configuration. The identifier may be sent together with an LTM cell switch command, indicating for the UE to perform an LTM cell switch to the associated LTM candidate cell.

The phrase “LTM cell switch procedure” refers to the process of a UE switching (or changing) its cell from a source cell to a target cell (i.e., an LTM candidate cell) using LTM. An LTM cell switch procedure may also be referred to as “L1/L2 based inter-cell mobility execution”, “LTM execution”, “dynamic switch”, “LTM switch”, “(LTM) cell switch”, “(LTM) serving cell change”, or “(LTM) cell change”. Similarly, the phrase “switching to an LTM candidate cell configuration” means that the UE applies an LTM candidate cell configuration such that the associated candidate cell becomes its new special cell (SpCell), e.g., PCell for LTM in MCG or PSCell for LTM in SCG.

Embodiments will now be described in more detail. A potential issue with triggering an RLC status report after LTM cell switch with HARQ reset is if the receiver of the RLC status report has not successfully received any PDUs in the target cell. In such case, the receiver will set the ACK SN in the RLC status PDU to the SN of the next unreceived RLC PDU in the source cell, and not indicate any status for later-transmitted RLC PDUs in the source cell.

In some embodiments, the transmitter tags each transmitted RLC PDU with a cell index. If the transmitter then receives an RLC status PDU via a cell A indicating an ACK_SN for an RLC PDU transmitted on cell B (i.e., tagged with cell B index), the transmitter treats all subsequent SNs (i.e., from ACK_SN to last transmitted SN on cell B) as negatively acknowledged and retransmits RLC PDUs corresponding to these SNs.

In other embodiments, the retransmission of these PDUs (i.e., from ACK SN to last transmitted SN in RLC transmission window) is triggered by a separate indication from MAC or RRC that there is a LTM cell switch. In these embodiments, the RLC transmitter does not need to tag each PDU in the transmit window with a cell index.

For DL RLC transmissions, this can be up to network implementation provided that the LTM cell switch interruption is long enough such that no PDSCH transmissions via source cell are still being processed when the UE is forming the RLC status PDU.

Some embodiments include methods for a UE to manage data retransmission during LTM cell switch. The UE can receive from a RAN node at least one LTM candidate cell configuration, with each received configuration associated with a corresponding LTM candidate cell. The UE can perform an LTM cell switch procedure to one of the LTM candidate cells and, during or after the LTM cell switch procedure, initiates (or triggers) a retransmission of data (e.g., RLC PDUs) lost due to the LTM cell switch procedure. In some embodiments, the UE performs the LTM cell switch procedure in response to an LTM cell switch command receive from a source or serving RAN node.

In some embodiments, the UE performs an L2 (e.g., MAC) reset in conjunction with the LTM cell switch procedure and/or in response to the LTM cell switch command. In some embodiments, the L2 reset includes a HARQ reset that involves at least one of the following operations:
setting a new data indicator (NDI) for an UL HARQ process to zero;
flushing soft buffers for a DL HARQ process; and
consider a next-received transmission of a transport block (TB) as an initial transmission for a DL HARQ process.

In some embodiments, the UE can initiate UL data retransmission, e.g., of UL RLC AMD PDUs. In some of these embodiments, the UE receives one or more RLC status reports from the source RAN node or a target RAN node, which causes the UE to initiate UL data retransmission to the target RAN node after the LTM cell switch procedure.

In some of these embodiments, after the LTM cell switch procedure, the UE transmits to the target RAN node an initial RLC PDU having a polling bit set. This causes the target RAN node to transmit the one or more RLC status reports, which causes the UE to initiate UL data retransmission to the target RAN node.

In some of these embodiments, initiating the UL data retransmission can involve various inter-UE operations, including the following:
UE MAC layer indicates to UE RLC layer that transmission of some RLC PDUs failed;
UE MAC layer indicates to UE RLC layer the SNs of RLC PDUs discarded during MAC reset;
UE MAC layer indicates to UE RLC layer the number (i.e., quantity) of RLC PDUs discarded during MAC reset; or
UE MAC layer indicates to UE RLC layer that some RLC PDUs were discarded during MAC reset.

In other embodiments, the UE can initiate DL data retransmission, e.g., of DL RLC AMD PDUs. For example, the UE can initiate retransmission of DL RLC AMD PDUs by transmitting one or more RLC status reports to the source RAN node (in source cell before LTM procedure) or to the target RAN node (in target cell after LTM procedure). The RLC status report(s) can cause the target RAN node to initiate retransmission of the DL RLC PDUs to the UE in the target cell.

In some of these embodiments, the RLC status report(s) are transmitted by the UE responsive to an indication by the RAN, which can be any of the following:
Included in or with the LTM cell switch command, e.g., in MAC signaling;
Included with DL RLC PDUs received in the source cell prior to the LTM cell switch command, e.g., with respective polling bits set; or
Included in or with the LTM candidate cell configuration, e.g., in RRC signaling.

In some embodiments, initiating the DL data retransmission can include stopping an RLC timer (e.g., t-StatusProhibit) that prevents transmission of RLC status reports when running. Stopping this timer will cause the UE to transmit RLC status reports more quickly, relative to waiting until after the running timer expires. Since it causes the target RAN node to receive the RLC status reports more quickly, the UE stopping the timer causes the target RAN node to retransmit DL RLC PDUs more quickly after the LTM cell switch procedure.

In some embodiments, stopping the RLC timer called t-StatusProhibit can involve or be responsive to various inter-UE operations, including the following:
UE RRC layer send UE RLC layer an indication to stop the RLC timer; or
UE MAC layer send UE RLC layer an indication to stop the RLC timer.

In other embodiments, stopping the RLC timer (e.g., t-StatusProhibit) can involve or be responsive to an indication from the source RAN node or the target RAN node. For example, the indication to stop the RLC timer can be included in or with the LTM candidate cell configuration, e.g., in an RRC message. As another example, the indication can be included in or with the LTM cell switch command, e.g., in a MAC message.

Other embodiments include complementary methods for the source RAN node (e.g., DU) to manage data retransmission in relation to UE LTM cell switch. The source RAN node can send to the UE at least one LTM candidate cell configuration, with each configuration associated with a corresponding LTM candidate cell. The source RAN node can transmit an LTM cell switch command to the UE, causing the UE to perform an LTM cell switch procedure to one of the LTM candidate cells. During or before the LTM cell switch procedure, the source RAN node can initiate (or trigger) a retransmission of data (e.g., RLC PDUs) lost due to the LTM cell switch procedure. In some embodiments, transmitting the LTM cell switch command can trigger an L2 (e.g., MAC) reset in the UE, such as discussed above. For example, the UE's MAC reset can involve any of the operations discussed above in relation to UE embodiments.

In some embodiments, the source RAN node can perform an L2 (e.g., MAC) reset for communication with the UE, in conjunction with the LTM cell switch procedure and/or in response to the LTM cell switch command sent to the UE. In some embodiments, the L2 reset includes a HARQ reset that involves at least one of the following operations:
setting a new data indicator (NDI) for an DL HARQ process to zero;
flushing soft buffers for an UL HARQ process; and
consider a next-received transmission of a transport block (TB) as an initial transmission for a UL HARQ process.

In some embodiments, the source RAN node can initiate UL data retransmission, e.g., of UL RLC AMD PDUs. In some of these embodiments, the source RAN node sends to the UE one or more RLC status reports, which causes the UE to initiate UL data retransmission to the target RAN node after the LTM cell switch procedure. In some embodiments, the RLC status report(s) can be sent to the UE together with the LTM cell switch command, e.g., in the same MAC PDU or in another MAC PDU that is concatenated.

In other embodiments, the source RAN node can initiate DL data retransmission, e.g., of DL RLC AMD PDUs. In some of these embodiments, the source RAN node can send to the UE an indication that causes the UE to send RLC status report(s) to the target RAN node after LTM cell switch. For example, the indication from the source RAN node can be any of the following:
Included in or with the LTM cell switch command, e.g., in MAC signaling;
Included with DL RLC PDUs transmitted in the source cell prior to the LTM cell switch command, e.g., with respective polling bits set; or
Included in or with the LTM candidate cell configuration, e.g., in RRC signaling.

In some embodiments, the source RAN node can send to the UE an indication that causes the UE to stop an RLC timer (e.g., t-StatusProhibit) that prevents transmission of RLC status reports when running. Stopping this timer will cause the UE to transmit RLC status reports more quickly, relative to waiting until after the running timer expires. For example, the indication to stop the RLC timer can be included in or with the LTM candidate cell configuration, e.g., in an RRC message. As another example, the indication can be included in or with the LTM cell switch command, e.g., in a MAC message. The indication to stop the RLC timer can be the same indication that causes the UE to send RLC status reports, discussed above, or a different indication. Other embodiments include complementary methods for the target RAN node (e.g., DU) to manage data retransmission in relation to UE LTM cell switch. The target RAN node can receive from the UE an LTM cell switch complete message (e.g., RRCReconfigurationComplete), indicating that the UE has completed an LTM cell switch to a cell served by the target RAN node. In response to the LTM cell switch complete message, the target RAN node can initiate (or trigger) a retransmission of data (e.g., RLC PDUs) lost due to the LTM cell switch procedure.

In some embodiments, the LTM cell switch complete message can be received after the UE has completed a MAC reset, which can include any of the operations mentioned above in relation to UE embodiments. In some embodiments, during or after the LTM cell switch procedure, the target RAN node can perform an L2 (e.g., MAC) reset for communication with the UE. In some of these embodiments, the L2 reset includes a HARQ reset that involves at least one of the following operations:
setting a new data indicator (NDI) for an DL HARQ process to zero;
flushing soft buffers for an UL HARQ process; and
consider a next-received transmission of a transport block (TB) as an initial transmission for a UL HARQ process.

In some embodiments, the target RAN node can initiate UL data retransmission, e.g., of UL RLC AMD PDUs. For example, the target RAN node sends to the UE one or more RLC status reports, which causes the UE to initiate UL data retransmission to the target RAN node. In some variants, the target RAN node can receive from the UE one or more RLC PDUs with respective polling bits set, which causes the target RAN node to transmit the one or more RLC status reports.

In other embodiments, the target RAN node can initiate DL data retransmission, e.g., of DL RLC AMD PDUs. For example, the target RAN node can receive from the UE one or more RLC status reports after the LTM cell switch. The RLC status reports can cause the target RAN node to retransmit the RLC PDUs. In some variants, the target RAN node can send to the UE one or more RLC PDUs with respective polling bits set, which causes the UE to transmit the one or more RLC status reports.

In some embodiments, the target RAN node can send to the UE an indication that causes the UE to stop an RLC timer (e.g., t-StatusProhibit) that prevents transmission of RLC status reports when running. Stopping this timer will cause the UE to transmit RLC status reports more quickly, relative to waiting until after the running timer expires. For example, the indication to stop the RLC timer can be included in or with the one or more RLC PDUs with respective polling bits set, mentioned above. As another example, the indication can be sent instead of, or separate from, the one or more RLC PDUs with respective polling bits set.

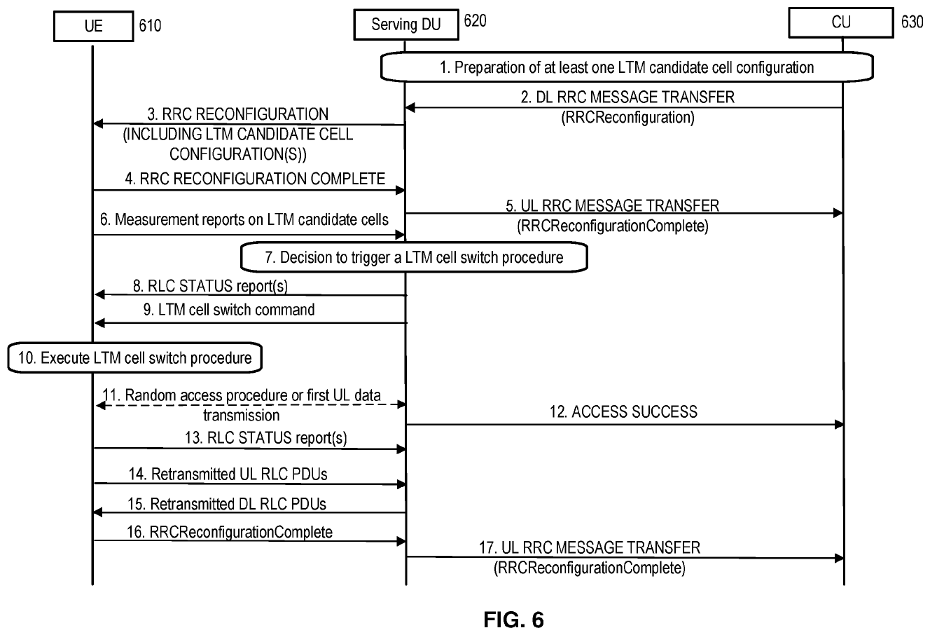

FIG. 6 shows a signaling diagram for an intra-DU LTM cell switch procedure, according to some embodiments of the present disclosure. In the context of the above description of various embodiments, the serving DU (620) is both the source RAN node and the target RAN node. Although the operations shown in FIG. 6 are given numerical labels, this is done to facilitate explanation rather than to require or imply any specific operational order, unless expressly stated otherwise.

In operation 1, the CU (630) and serving DU prepare at least one LTM candidate cell configuration for the UE (610). In operation 2, the CU transmits to the Serving DU an DL RRC MESSAGE TRANSFER over the F1 interface. This message includes an embedded RRCReconfiguration message containing the at least one LTM candidate cell configuration prepared in operation 1. In operation 3, the serving DU forwards the RRCReconfiguration message to the UE.

In operation 4, the UE stores the received LTM candidate cell configuration(s) and responds to the serving DU with an RRCReconfigurationComplete message. In operation 5, the serving DU forwards the received RRCReconfigurationComplete message to the CU in an UL RRC MESSAGE TRANSFER message via the F1 interface.

In operation 6, the UE measures the configured LTM candidate cells and transmits lower layer measurement reports (e.g., including CSI measurements) to the serving DU. In operation 7, based on the measurement reports, the serving DU decides to trigger an LTM cell switch procedure to one of the LTM candidate cells, specifically a candidate cell provided by the serving DU. In operation 8, the Serving DU transmits one or more RLC STATUS reports to the UE. The RLC STATUS report(s) trigger(s) the UE to retransmit any UL RLC PDUs that becomes lost during HARQ reset performed by the UE as result of the LTM cell switch procedure.

In operation 9, the serving DU transmits an LTM cell switch command to the UE to trigger the LTM cell switch procedure. The LTM cell switch command contains an indication of the LTM candidate cell configuration for the LTM candidate cell. After determining that the UE received LTM cell switch command (e.g., by HARQ ACK, not shown), the serving DU performs a HARQ reset.

In operation 10, in response to the LTM cell switch command, the UE executes the LTM cell switch procedure by applying the LTM candidate cell configuration (i.e., indicated by the command) and switching to the target cell. In this example, the UE also performs a HARQ reset during the LTM cell switch procedure. In some embodiments, the LTM cell switch command or in the LTM candidate cell configuration can include an indication of whether or not to perform HARQ reset in conjunction with the LTM cell switch procedure.

In operation 11, the UE transmits its initial UL data or signalling in the target cell to the serving DU, possibly after performing a random access procedure (shown as dashed line). In operation 12, in response to the initial UL data or signalling from the UE, the serving DU transmits to the CU an ACCESS SUCCESS indicating the UE arrival in the target cell. In operation 13, the UE transmits one or more RLC STATUS reports to the serving DU in the target cell. This will trigger the serving DU to retransmit DL RLC PDUs that were lost during the HARQ reset that was performed by the serving DU in operation 9.

In operation 14, based on the RLC STATUS report(s) received in operation 8, the UE retransmits UL RLC PDUs that were lost during the HARQ reset performed by the UE during the LTM cell switch procedure in operation 10. In some embodiments, these retransmitted UL RLC PDUs may be the initial UL data transmission in operation 11.

In operation 15, based on the RLC STATUS report(s) received in operation 13, the serving DU retransmits DL RLC PDUs that were lost during the HARQ reset that was performed by the serving DU in operation 9. In operation 16, the UE transmits an LTM cell switch complete message (e.g., RRCReconfigurationComplete) in the target cell to the Serving DU. In operation 17, the Serving DU forwards the message received in operation 16 to the CU in an UL RRC MESSAGE TRANSFER message via F1 interface.

Techniques of the present disclosure can also be embodied in 3GPP specifications. The following is some example text for 3GPP TS 38.331 (RRC specification), with ellipses denoting text that has been omitted for brevity and underline denoting text that is particularly relevant for embodiments of the present disclosure.

### * * * Begin 3GPP 38.331 Text * * *

5.3.5.x LTM configuration and execution
5.3.5.x.1 General
   The UE shall perform the following actions based on a received LTM-CandidateConfig IE:
   1> store the received Itm-ReferenceConfiguration in VarLTM-Config, if present;
1> if the LTM-CandidateConfig includes the ltm-Candidate ToReleaseList:
   2> perform the LTM candidate cell release as specified in 5.3.5.x.2;
1> if the LTM-CandidateConfig includes the ltm-CandidateResetL 2-List:

2> add the received Itm-Candidate ResetL 2-List to VarLTM-Config,
1> if the LIM-CandidateConfig includes the ltm-CandidateToAddModList:

2> perform the LTM candidate cell addition or reconfiguration as specified in 5.3.5.x.3;
1> perform the actions to generate a complete LTM configuration as specified in 5.3.5.x.4;
5.3.5.x.2 LTM Candidate Cell Release
. . .
5.3.5.x.3 LTM candidate cell addition/modification
5.3.5.x.4 Generation of UE LTM configuration
5.3.5.x.5 LTM cell switch execution
   Upon the indication by lower layers that an LTM cell switch procedure is triggered, the UE shall:
1> release/clear all current dedicated radio configuration except for the following:
   2> if the LTM cell switch is triggered on the MCG:
      the MCG C-RNTI;
      the AS security configurations associated with the master key;
   2> else, if the LTM cell switch is triggered on the SCG:
      the SCG C-RNTI;
      the AS security configurations associated with the secondary key;
   the SRB1/SRB2 configurations and DRB configurations as configured by radioBearerConfig or radioBearerConfig2;
      Editor's Note: FFS on whether the radio bearer needs to be kept when execution the LTM cell switch.
   the UE variables VarLTM-Config and VarLTM-UE-Config.
1> apply the LTM configuration in UE-LTM-Config within VarLTM-UE-Config related to the LTM candidate cell configuration identity as received by lower layers.
1> indicate to each configured RLC bearer to trigger a STATUS PDU.
1> submit the RRCReconfigurationComplete message to lower layers for transmission using the new configuration.
   * * * End 3GPP 38.331 text * * *

The following is some example text for 3GPP TS 38.322 (RLC specification), with ellipses denoting text that has been omitted for brevity and underline denoting text that is particularly relevant for embodiments of the present disclosure.

### * * * Begin 3GPP 38.322 Text * * *

5.3.4 Status reporting
   An AM RLC entity sends STATUS PDUs to its peer AM RLC entity in order to provide positive and/or negative acknowledgements of RLC SDUs (or portions of them).
   Triggers to initiate STATUS reporting include:
   . . .
   upon indication from upper layers to trigger a STATUS PDU.
      When STATUS reporting has been triggered, the receiving side of an AM RLC entity shall:
   if t-StatusProhibit is not running: or
   if the STATUS reporting was triggered by an indication from upper layers:
      at the first transmission opportunity indicated by lower layer, construct a STATUS PDU and submit it to lower layer.
   else:
      at the first transmission opportunity indicated by lower layer after t-StatusProhibit expires, construct a single STATUS PDU even if status reporting was triggered several times while t-StatusProhibit was running and submit it to lower layer.
         When a STATUS PDU has been submitted to lower layer, the receiving side of an AM RLC entity shall:
start t-statusprohibit.
   When constructing a STATUS PDU, the AM RLC entity shall:
   for the RLC SDUs with SN such that RX_Next<=SN<RX_Highest_Status that has not been completely received yet, in increasing SN order of RLC SDUs and increasing byte segment order within RLC SDUs, starting with SN=RX_Next up to the point where the resulting STATUS PDU still fits to the total size of RLC PDU(s) indicated by lower layer:
      for an RLC SDU for which no byte segments have been received yet:
         include in the STATUS PDU a NACK SN which is set to the SN of the RLC SDU.
      for a continuous sequence of byte segments of a partly received RLC SDU that have not been received yet:
         include in the STATUS PDU a set of NACK SN, SOstart and SOend.
      for a continuous sequence of RLC SDUs that have not been received yet:
         include in the STATUS PDU a set of NACK SN and NACK range;
include in the STATUS PDU, if required, a pair of SOstart and SOend.
set the ACK SN to the SN of the next not received RLC SDU which is not indicated as missing in the resulting STATUS PDU.

### * * * End 3GPP 38.322 Text * * *

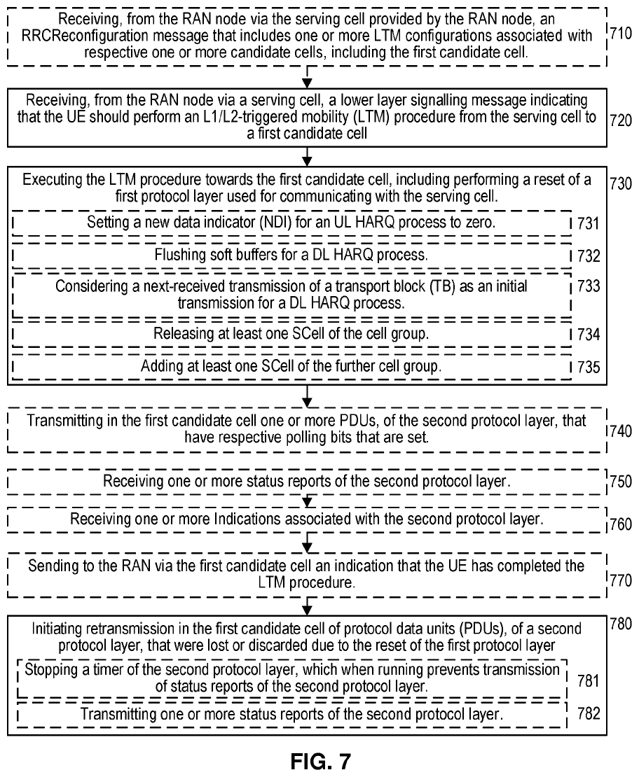

The embodiments described above can be further illustrated with reference to FIGS. 7-9, which depict exemplary methods (e.g., procedures) for a UE, a source RAN node, and a target RAN node, respectively. Put differently, various features of the operations described below correspond to various embodiments described above. The exemplary methods shown in FIGS. 7-9 can be used cooperatively to provide benefits, advantages, and/or solutions to problems described herein. Although the exemplary methods are illustrated in FIGS. 7-9 by specific blocks in particular orders, the operations corresponding to the blocks can be performed in different orders than shown and can be combined and/or divided into blocks and/or operations having different functionality than shown. Optional blocks or operations are indicated by dashed lines. More specifically, FIG. 7 illustrates an exemplary method (e.g., procedure) for a UE configured to communicate with a RAN node, according to various embodiments of the present disclosure. The exemplary method shown in FIG. 7 can be performed by a UE (e.g., wireless device) such as described elsewhere herein.

The exemplary method includes the operations of block 720, where the UE receives, from the RAN node via a serving cell, a lower layer signalling message indicating that the UE should perform an L1/L2-triggered mobility (LTM) procedure from the serving cell to a first candidate cell. The exemplary method also includes the operations of block 730, where the UE executes the LTM procedure towards the first candidate cell, including performing a reset of a first protocol layer used for communicating with the serving cell. The exemplary method also includes the operations of block 780, where after executing the LTM procedure, the UE initiates retransmission in the first candidate cell of protocol data units (PDUs) of a second protocol layer, which were lost or discarded due to the reset of the first protocol layer.

In some embodiments, the first candidate cell and the serving are provided by the RAN node (e.g., different DUs) or by a same DU of the RAN node. In some embodiments, one or more of the following applies: the first protocol layer is below the second protocol layer, and the lower layer signaling message is a message of the first protocol layer.

In some embodiments, the first protocol layer is medium access control (MAC) and the second protocol layer is radio link control (RLC). In some embodiments, one or more of the following applies: the lower layer signaling message is at a protocol layer below the RRC protocol layer, and the lower layer signaling message is a MAC Control Element (MAC CE) or PHY Downlink Control Information (DCI).

In some embodiments, performing the reset of the first protocol layer comprises in block 730 includes one or more of the following operations, labelled with corresponding sub-block numbers:
(731) setting a new data indicator (NDI) for an UL HARQ process to zero;
(732) flushing soft buffers for a DL HARQ process; and
(733) considering a next-received transmission of a transport block (TB) as an initial transmission for a DL HARQ process.

In some embodiments, the lost or discarded PDUs of the second protocol layer include uplink (UL) PDUs transmitted via the serving cell. In some of these embodiments, the exemplary method also includes the operations of block 750, where the UE receives one or more status reports of the second protocol layer. The one or more status reports can be received in the serving cell before executing the LTM procedure or in the first candidate cell after executing the LTM procedure. In these embodiments, initiating retransmission of the UL PDUs in block 780 is responsive to the one or more status reports.

In some variants of these embodiments, the exemplary method also includes the operations of block 740, where after executing the LTM procedure in block 730, the UE transmits in the first candidate cell one or more PDUs, of the second protocol layer, that have respective polling bits that are set. In such case, the one or more status reports are received (e.g., in block 750) in the first candidate cell responsive to the one or more PDUs having respective polling bits that are set.

In other of these embodiments, initiating retransmission of the UL PDUs in block 780 is responsive to the one or more of the following indications from the first protocol layer to the second protocol layer in the UE:
an indication that transmission of some PDUs of the second protocol layer has failed;
an indication that one or more PDUs of the second protocol layer were discarded during reset of the first protocol layer;
an indication of sequence numbers (SN) of PDUs of the second protocol layer that were discarded during reset of the first protocol layer; and
an indication of how many PDUs of the second protocol layer were discarded during reset of the first protocol layer.

In some embodiments, the lost or discarded PDUs of the second protocol layer include downlink (DL) PDUs transmitted via the serving cell. In such embodiments, initiating retransmission of the DL PDUs in block 780 includes the operations of sub-block 782, where the UE transmits one or more status reports of the second protocol layer. The one or more status reports can be transmitted in the serving cell before executing the LTM procedure or in the first candidate cell after executing the LTM procedure.

In some of these embodiments, initiating retransmission of the DL PDUs in block 780 also includes the operations of sub-block 781, where the UE stops a timer (e.g., t-StatusProhibit), of the second protocol layer, that when running prevents transmission of status reports of the second protocol layer.

In some of these embodiments, transmitting the one or more status reports in sub-block 782 is responsive to the operations of block 760, where the UE receives one or more of the following indications from the RAN node: an indication to transmit the one or more status reports of the second protocol layer; and an indication to stop a timer of the second protocol layer, which when running prevents transmission of status reports of the second protocol layer. In some variants of these embodiments, the one or more indications are received in the serving cell before executing the LTM procedure. In other variants, the one or more indications are received in the first candidate cell after executing the LTM procedure.

In some variants of these embodiments, the one or more indications are included in or with one of the following:
the lower layer signaling message (e.g., in block 720);
an LTM configuration associated with the first candidate cell, wherein the LTM configuration is received from the RAN node in an RRCReconfiguration message; or
or one or more PDUs of the second protocol layer that were received in the serving cell or in the first candidate cell.

In some further variants, the one or more PDUs of the second protocol layer have respective polling bits that are set.

In some embodiments, the exemplary method also includes the operations of block 710, where the UE receives, via the serving cell from the RAN node, an RRCReconfiguration message that includes one or more LTM configurations associated with respective one or more candidate cells, including the first candidate cell. In some embodiments, the exemplary method also includes the operations of block 770, where after executing the LTM procedure to the first candidate cell, the UE sends to the RAN via the first candidate cell an indication that the UE has completed the LTM procedure.

In some embodiments, the serving cell is a primary cell (PCell) or a special cell (SpCell) of a cell group that also includes one or more secondary cells (SCells), and the first candidate cell is a PCell or an SpCell of a further cell group that also includes one or more SCells. In such embodiments, executing the LTM procedure towards the first candidate cell in block 730 also includes one or more of the following operations, labelled with corresponding sub-block numbers:
(734) releasing at least one SCell of the cell group, and
(735) adding at least one SCell of the further cell group.

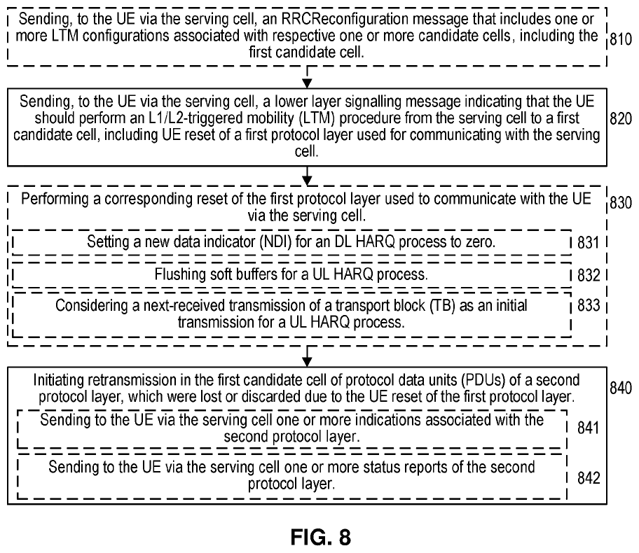

In addition, FIG. 8 illustrates an exemplary method (e.g., procedure) for a RAN node configured to provide a serving cells for UEs, according to various embodiments of the present disclosure. The exemplary method shown in FIG. 8 can be performed by a RAN node (e.g., base station, gNB, etc.) or part(s) thereof (e.g., CU, DU) such as described elsewhere herein.

The exemplary method includes the operations of block 820, where the RAN node sends, to the UE via the serving cell, a lower layer signalling message indicating that the UE should perform an L1/L2-triggered mobility (LTM) procedure from the serving cell to a first candidate cell, including UE reset of a first protocol layer used for communicating with the serving cell. The exemplary method also includes the operations of block 840, where the RAN node initiates retransmission in the first candidate cell of PDUs of a second protocol layer, which were lost or discarded due to the UE reset of the first protocol layer.

In some embodiments, the first candidate cell and the serving cell are provided by the RAN node (e.g., different DUs) or by a same DU of the RAN node. In some embodiments, one or more of the following applies: the first protocol layer is below the second protocol layer, and the lower layer signaling message is a message of the first protocol layer.

In some embodiments, the first protocol layer is MAC and the second protocol layer is RLC. In some embodiments, one or more of the following applies: the lower layer signaling message is at a protocol layer below the RRC protocol layer, and the lower layer signaling message is a MAC Control Element (MAC CE) or PHY Downlink Control Information (DCI).

In some embodiments, the exemplary method also includes the operations of block 830, where based on sending the lower layer signaling message in block 820, the RAN node performs a corresponding reset of the first protocol layer used to communicate with the UE via the serving cell, including one or more of the following operations labelled with corresponding sub-block numbers:
(831) setting a new data indicator (NDI) for a DL HARQ process to zero;
(832) flushing soft buffers for an UL HARQ process; and
(833) considering a next-received transmission of a transport block (TB) as an initial transmission for an UL HARQ process.

In some embodiments, the lost or discarded PDUs of the second protocol layer include UL PDUs transmitted via the serving cell. In such embodiments, initiating retransmission of the UL PDUs in block 840 includes the operations of sub-block 841, where the RAN node sends to the UE via the serving cell one or more status reports of the second protocol layer. Note that reception of the one or more status reports causes the UE to initiate retransmission of the UL PDUs in the first candidate cell, as described above in relation to UE embodiments. In some of these embodiments, the one or more status reports are sent to the UE together with the lower layer signaling message in block 820.

In some embodiments, the lost or discarded PDUs of the second protocol layer include DL PDUs transmitted via the serving cell. In such embodiments, initiating retransmission of the DL PDUs in block 840 includes the operations of sub-block 842, where the RAN node sends to the UE via the serving cell one or more of the following indications:
an indication to transmit one or more status reports, of the second protocol layer, in the candidate target cell; and
an indication to stop a timer of the second protocol layer, which when running prevents transmission of status reports of the second protocol layer.

In some of these embodiments, the one or more indications are included in or with one of the following:
the lower layer signaling message (e.g., in block 820);
an LTM configuration associated with the first candidate cell, wherein the LTM configuration is sent to the UE in an RRCReconfiguration message; or
one or more PDUs of the second protocol layer that were transmitted in the serving cell before the lower layer signaling message.

In some variants of these embodiments, the one or more PDUs of the second protocol layer have respective polling bits that are set.

In some embodiments, the exemplary method also includes the operations of block 810, where the RAN node sends, to the UE via the serving cell, an RRCReconfiguration message that includes one or more LTM configurations associated with respective one or more candidate cells, including the first candidate cell.

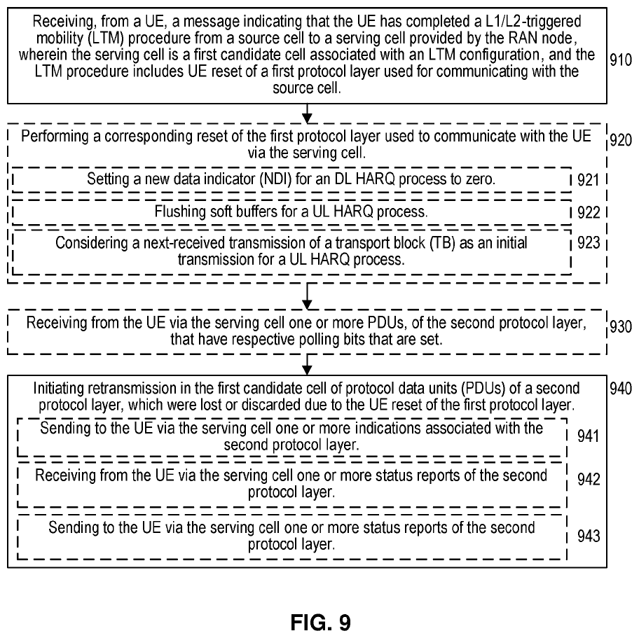

In addition, FIG. 9 illustrates an exemplary method (e.g., procedure) for a RAN node configured to provide a serving cells for UEs, according to various embodiments of the present disclosure. The exemplary method shown in FIG. 9 can be performed by a RAN node (e.g., base station, gNB, etc.) or part(s) thereof (e.g., CU, DU) such as described elsewhere herein.

The exemplary method includes the operations of block 910, where the RAN node receives, from a UE, a message indicating that the UE has completed an LTM procedure from a source cell to a serving cell provided by the RAN node. The serving cell is a first candidate cell and the LTM procedure includes UE reset of a first protocol layer used for communicating with the source cell. The exemplary method also includes the operations of block 940, where the RAN node initiates retransmission in the serving cell of PDUs of a second protocol layer, which were lost or discarded due to the UE reset of the first protocol layer.

In some embodiments, the source cell and the serving cell are provided by the RAN node (e.g., different DUs) or by a same DU of the RAN node. In some embodiments, one or more of the following applies: the first protocol layer is below the second protocol layer, and the lower layer signaling message is a message of the first protocol layer.

In some embodiments, the first protocol layer is MAC and the second protocol layer is RLC. In some embodiments, one or more of the following applies: the lower layer signaling message is at a protocol layer below the RRC protocol layer, and the lower layer signaling message is a MAC Control Element (MAC CE) or PHY Downlink Control Information (DCI). In some embodiments, the exemplary method also includes the operations of block 920, where based on the message in block 910, the RAN node performs a corresponding reset of the first protocol layer used to communicate with the UE via the serving cell, including one or more of the following operations labelled with corresponding sub-block numbers:
(921) setting a new data indicator (NDI) for a DL HARQ process to zero;
(922) flushing soft buffers for an UL HARQ process; and
(923) considering a next-received transmission of a transport block (TB) as an initial transmission for an UL HARQ process.

In some embodiments, the lost or discarded PDUs of the second protocol layer include UL PDUs transmitted via the source cell. In such embodiments, initiating retransmission of the UL PDUs in block 940 includes the operations of sub-block 943, where the RAN node sends, to the UE via the serving (i.e., first candidate) cell, one or more status reports of the second protocol layer. Note that reception of the one or more status reports causes the UE to initiate retransmission of the UL PDUs in the serving cell, such as described above for UE embodiments.

In some of these embodiments, the exemplary method also includes the operations of block 930, where the RAN node receives from the UE via the serving cell one or more PDUs, of the second protocol layer, that include respective polling bits that are set. In such embodiments, sending the one or more status reports to the UE in block 943 is responsive to receiving the one or more PDUs having respective polling bits that are set in block 930.

In some embodiments, the lost or discarded PDUs of the second protocol layer include DL PDUs transmitted via the source cell. In such embodiments, initiating retransmission of the DL PDUs in block 940 includes the operations of block 942, where the RAN node receives from the UE via the serving (i.e., first candidate) cell one or more status reports of the second protocol layer. In some of these embodiments, initiating retransmission of the DL PDUs in block 940 also includes the operations of sub-block 941, where the RAN node sends to the UE via the serving cell one or more of the following indications:
an indication to transmit the one or more status reports; and
an indication to stop a timer, of the second protocol layer, that prevents transmission of status reports of the second protocol layer when running.

In such embodiments, the one or more status reports are received responsive to the one or more indications. In some variants of these embodiments, the one or more indications are included in or with one or more PDUs of the second protocol layer. In some further variants, the one or more PDUs of the second protocol layer have respective polling bits that are set.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

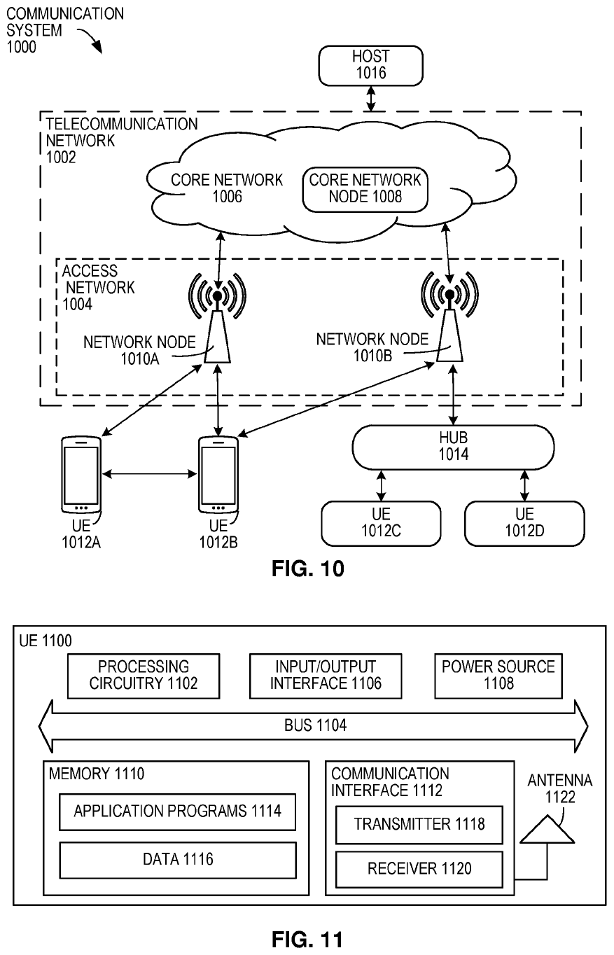

FIG. 10 shows an example of a communication system 1000 in accordance with some embodiments. In this example, communication system 1000 includes a telecommunication network 1002 that includes an access network 1004 (e.g., RAN) and a core network 1006, which includes one or more core network nodes 1008. Access network 1004 includes one or more access network nodes, such as network nodes 1010a-b (one or more of which may be generally referred to as network nodes 1010), or any other similar 3GPP access nodes or non-3GPP access points.

Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, telecommunication network 1002 includes one or more Open-RAN (ORAN) network nodes. An ORAN network node is a node in telecommunication network 1002 that supports an ORAN specification (e.g., a specification published by the O-RAN Alliance, or any similar organization) and may operate alone or together with other nodes to implement one or more functionalities of any node in telecommunication network 1002, including one or more network nodes 1010 and/or core network nodes 1008.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. Network nodes 1010 facilitate direct or indirect connection of UEs, such as by connecting UEs 1012a-d (one or more of which may be generally referred to as UEs 1012) to core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1000 may include any number of wired or wireless networks, network nodes, UEs, and/or any other components or systems that may facilitate or participate in the communication of data and/or signals whether via wired or wireless connections. Communication system 1000 may include and/or interface with any type of communication, telecommunication, data, cellular, radio network, and/or other similar type of system.

UEs 1012 may be any of a wide variety of communication devices, including wireless devices arranged, configured, and/or operable to communicate wirelessly with network nodes 1010 and other communication devices. Similarly, network nodes 1010 are arranged, capable, configured, and/or operable to communicate directly or indirectly with UEs 1012 and/or with other network nodes or equipment in telecommunication network 1002 to enable and/or provide network access, such as wireless network access, and/or to perform other functions, such as administration in telecommunication network 1002.

In the depicted example, core network 1006 connects network nodes 1010 to one or more hosts, such as host 1016. These connections may be direct or indirect via one or more intermediary networks or devices. In other examples, network nodes may be directly coupled to hosts. Core network 1006 includes one or more core network nodes (e.g., 1008) that are structured with hardware and software components. Features of these components may be substantially similar to those described with respect to the UEs, network nodes, and/or hosts, such that the descriptions thereof are generally applicable to the corresponding components of core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1016 may be under the ownership or control of a service provider other than an operator or provider of access network 1004 and/or telecommunication network 1002, and may be operated by the service provider or on behalf of the service provider. Host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1002 is a cellular network that implements 3GPP standardized features. Accordingly, telecommunication network 1002 may support network slicing to provide different logical networks to different devices that are connected to telecommunication network 1002. For example, telecommunication network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1012 are configured to transmit and/or receive information without direct human interaction. For instance, a UE may be designed to transmit information to access network 1004 on a predetermined schedule, when triggered by an internal or external event, or in response to requests from access network 1004. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In some embodiments, one or more of UEs 1012 can be configured to perform operations attributed to a UE in various methods, procedures, and/or techniques described above, including in relation to FIGS. 6-9. Likewise, in some embodiments, one or more of network nodes 1010 can be configured to perform operations attributed to a RAN node in various methods, procedures, and/or techniques described above, including in relation to FIGS. 6-9.

In the example, hub 1014 communicates with access network 1004 to facilitate indirect communication between one or more UEs (e.g., 1012c and/or 1012d) and network nodes (e.g., 1010b). In some examples, hub 1014 may be a controller, router, content source and analytics, or any of the other communication devices described herein regarding UEs. For example, hub 1014 may be a broadband router enabling access to core network 1006 for the UEs. As another example, hub 1014 may be a controller that sends commands or instructions to one or more actuators in the UEs. Commands or instructions may be received from the UEs, network nodes 1010, or by executable code, script, process, or other instructions in hub 1014. As another example, hub 1014 may be a data collector that acts as temporary storage for UE data and, in some embodiments, may perform analysis or other processing of the data. As another example, hub 1014 may be a content source. For example, for a UE that is a VR headset, display, loudspeaker or other media delivery device, hub 1014 may retrieve VR assets, video, audio, or other media or data related to sensory information via a network node, which hub 1014 then provides to the UE either directly, after performing local processing, and/or after adding additional local content. In still another example, hub 1014 acts as a proxy server or orchestrator for the UEs, in particular if one or more of the UEs are low energy IoT devices.

Hub 1014 may have a constant/persistent or intermittent connection to network node 1010b. Hub 1014 may also allow for a different communication scheme and/or schedule between hub 1014 and UEs (e.g., 1012c and/or 1012d), and between hub 1014 and core network 1006. In other examples, hub 1014 is connected to core network 1006 and/or one or more UEs via a wired connection. Moreover, hub 1014 may be configured to connect to an M2M service provider over access network 1004 and/or to another UE over a direct connection. In some scenarios, UEs may establish a wireless connection with network nodes 1010 while still connected via hub 1014 via a wired or wireless connection. In some embodiments, hub 1014 may be a dedicated hub-that is, a hub whose primary function is to route communications to/from the UEs from/to network node 1010b. In other embodiments, hub 1014 may be a non-dedicated hub-that is, a device which is capable of operating to route communications between the UEs and network node 1010b, but which is additionally capable of operating as a communication start and/or end point for certain data channels.

FIG. 11 shows a UE 1100 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by 3GPP, including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1100 includes processing circuitry 1102 that is operatively coupled via bus 1104 to input/output interface 1106, power source 1108, memory 1110, communication interface 1112, and possibly other components not explicitly shown. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

Processing circuitry 1102 is configured to process instructions and data and may be configured to implement any sequential state machine operative to execute instructions stored as machine-readable computer programs in memory 1110. Processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1102 may include multiple central processing units (CPUs).

In the example, input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1108 is structured as a battery or battery pack. Other types of power sources, such as an external power source (e.g., an electricity outlet), photovoltaic device, or power cell, may be used. Power source 1108 may further include power circuitry for delivering power from power source 1108 itself, and/or an external power source, to the various parts of UE 1100 via input circuitry or an interface such as an electrical power cable. Delivering power may be, for example, for charging power source 1108. Power circuitry may perform any formatting, converting, or other modification to the power from power source 1108 to make the power suitable for the respective components of UE 1100 to which power is supplied.

Memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1110 includes one or more application programs 1114, such as an operating system, web browser application, a widget, gadget engine, or other application, and corresponding data 1116. Memory 1110 may store, for use by UE 1100, any of a variety of various operating systems or combinations of operating systems.

Memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1110 may allow UE 1100 to access instructions, application programs and the like, stored on transitory or non-transitory memory media, to off-load data, or to upload data. An article of manufacture, such as one utilizing a communication system may be tangibly embodied as or in memory 1110, which may be or comprise a device-readable storage medium.

Processing circuitry 1102 may be configured to communicate with an access network or other network using communication interface 1112. Communication interface 1112 may comprise one or more communication subsystems and may include or be communicatively coupled to an antenna 1122. Communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, transmitter 1118 and/or receiver 1120 may be coupled to one or more antennas (e.g., 1122) and may share circuit components, software or firmware, or alternatively be implemented separately. In the illustrated embodiment, communication functions of communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

In some embodiments, UE 1100 can be configured to perform operations attributed to a UE in various methods, procedures, and/or techniques described above, including in relation to FIGS. 6-9.

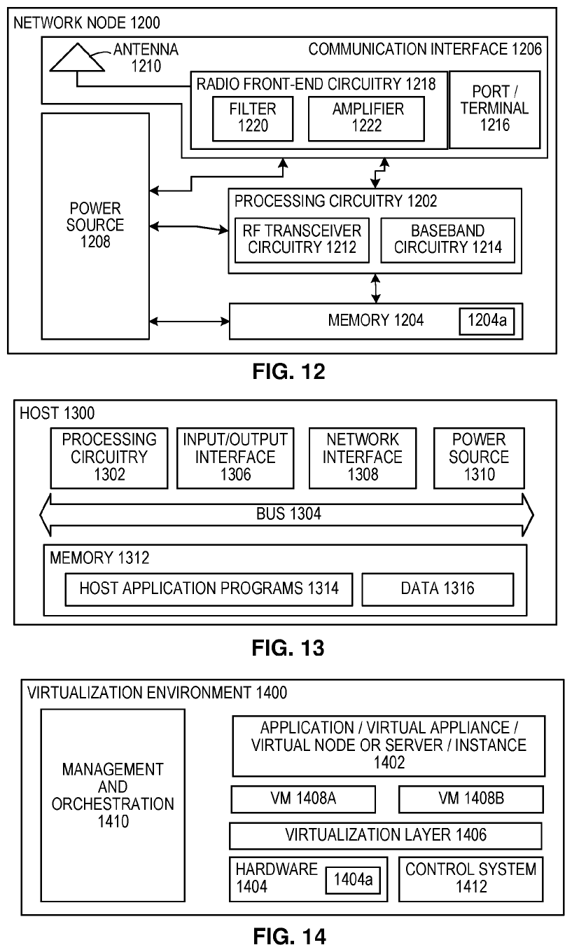

FIG. 12 shows a network node 1200 in accordance with some embodiments. Examples of network nodes include, but are not limited to, access points (APs) (e.g., radio access points), base stations (e.g., radio base stations, Node Bs, eNBs, gNBs), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1200 includes processing circuitry 1202, memory 1204, communication interface 1206, and power source 1208. Network node 1200 may be composed of multiple physically separate components (e.g., a NodeB component and a RNC component, or a BTS component and a BSC component, etc.), which may each have their own respective components. In certain scenarios in which network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). Network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

Processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as memory 1204, to provide network node 1200 functionality.

In some embodiments, processing circuitry 1202 includes a system on a chip (SOC). In some embodiments, processing circuitry 1202 includes one or more of radio frequency (RF) transceiver circuitry 1212 and baseband processing circuitry 1214. In some embodiments, RF transceiver circuitry 1212 and baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

Memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1202. Memory 1204 may store any suitable instructions, data, or information, including a computer program, software, an application including one or more of logic, rules, code, tables, and/or other instructions (collected denoted computer program 1204a, which may be in the form of a computer program product) capable of being executed by processing circuitry 1202 and utilized by network node 1200. Memory 1204 may be used to store any calculations made by processing circuitry 1202 and/or any data received via communication interface 1206. In some embodiments, processing circuitry 1202 and memory 1204 is integrated.

Communication interface 1206 is used in wired or wireless communication of signaling and/or data between a network node, access network, and/or UE. As illustrated, communication interface 1206 comprises port(s)/terminal(s) 1216 to send and receive data, for example to and from a network over a wired connection. Communication interface 1206 also includes radio front-end circuitry 1218 that may be coupled to, or in certain embodiments a part of, antenna 1210. Radio front-end circuitry 1218 comprises filters 1220 and amplifiers 1222. Radio front-end circuitry 1218 may be connected to an antenna 1210 and processing circuitry 1202. The radio front-end circuitry may be configured to condition signals communicated between antenna 1210 and processing circuitry 1202. Radio front-end circuitry 1218 may receive digital data that is to be sent out to other network nodes or UEs via a wireless connection. Radio front-end circuitry 1218 may convert the digital data into a radio signal having the appropriate channel and bandwidth parameters using a combination of filters 1220 and/or amplifiers 1222. The radio signal may then be transmitted via antenna 1210. Similarly, when receiving data, antenna 1210 may collect radio signals which are then converted into digital data by radio front-end circuitry 1218. The digital data may be passed to processing circuitry 1202. In other embodiments, the communication interface may comprise different components and/or different combinations of components.

In certain alternative embodiments, network node 1200 does not include separate radio front-end circuitry 1218, instead, processing circuitry 1202 includes radio front-end circuitry and is connected to antenna 1210. Similarly, in some embodiments, all or some of RF transceiver circuitry 1212 is part of communication interface 1206. In still other embodiments, communication interface 1206 includes one or more ports or terminals 1216, radio front-end circuitry 1218, and RF transceiver circuitry 1212, as part of a radio unit (not shown), and communication interface 1206 communicates with baseband processing circuitry 1214, which is part of a digital unit (not shown).

Antenna 1210 may include one or more antennas, or antenna arrays, configured to send and/or receive wireless signals. Antenna 1210 may be coupled to radio front-end circuitry 1218 and may be any type of antenna capable of transmitting and receiving data and/or signals wirelessly. In certain embodiments, antenna 1210 is separate from network node 1200 and connectable to network node 1200 through an interface or port.

Antenna 1210, communication interface 1206, and/or processing circuitry 1202 may be configured to perform any receiving operations and/or certain obtaining operations described herein as being performed by the network node. Any information, data and/or signals may be received from a UE, another network node and/or any other network equipment. Similarly, antenna 1210, communication interface 1206, and/or processing circuitry 1202 may be configured to perform any transmitting operations described herein as being performed by the network node. Any information, data and/or signals may be transmitted to a UE, another network node and/or any other network equipment.

Power source 1208 provides power to the various components of network node 1200 in a form suitable for the respective components (e.g., at a voltage and current level needed for each respective component). Power source 1208 may further comprise, or be coupled to, power management circuitry to supply the components of network node 1200 with power for performing the functionality described herein. For example, network node 1200 may be connectable to an external power source (e.g., the power grid, an electricity outlet) via an input circuitry or interface such as an electrical cable, whereby the external power source supplies power to power circuitry of power source 1208. As a further example, power source 1208 may comprise a source of power in the form of a battery or battery pack which is connected to, or integrated in, power circuitry. The battery may provide backup power should the external power source fail.

Embodiments of network node 1200 may include additional components beyond those shown in FIG. 12 for providing certain aspects of the network node's functionality, including any of the functionality described herein and/or any functionality necessary to support the subject matter described herein. For example, network node 1200 may include user interface equipment to allow input of information into network node 1200 and to allow output of information from network node 1200. This may allow a user to perform diagnostic, maintenance, repair, and other administrative functions for network node 1200.

In some embodiments, network node 1200 can be configured to perform operations attributed to a RAN node in various methods, procedures, and/or techniques described above, including in relation to FIGS. 6-9.

FIG. 13 is a block diagram of a host 1300, which may be an embodiment of host 1016 of FIG. 10, in accordance with various aspects described herein. As used herein, host 1300 may be or comprise various combinations hardware and/or software, including a standalone server, a blade server, a cloud-implemented server, a distributed server, a virtual machine, container, or processing resources in a server farm. Host 1300 may provide one or more services to one or more UEs.

Host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

Memory 1312 may include one or more computer programs including one or more host application programs 1314 and data 1316, which may include user data, e.g., data generated by a UE for host 1300 or data generated by host 1300 for a UE. Embodiments of host 1300 may utilize only a subset or all of the components shown. Host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1314 may also provide for user authentication and licensing checks and may periodically report health, routes, and content availability to a central node, such as a device in or on the edge of a core network. Accordingly, host 1300 may select and/or indicate a different host for over-the-top services for a UE. Host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

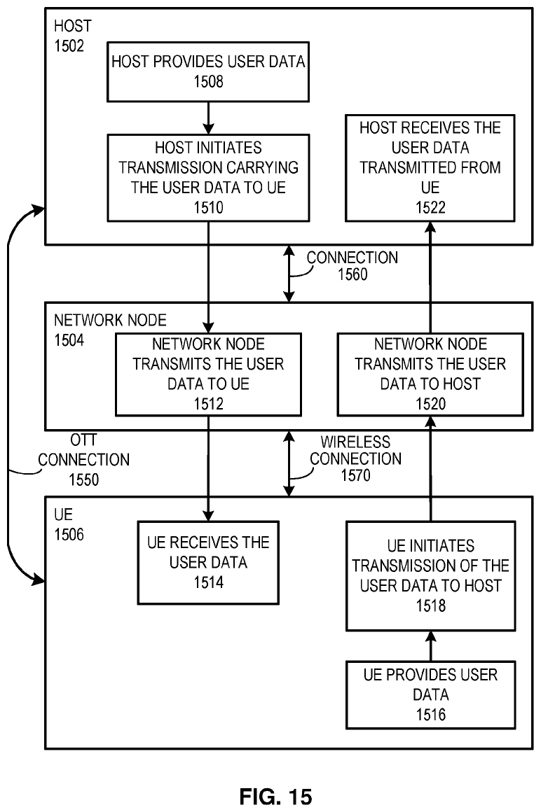

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1400 includes components defined by the O-RAN Alliance, such as an O-Cloud environment orchestrated by a Service Management and Orchestration Framework via an O-2 interface.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein. In some embodiments, virtualization environment 1400 can host and/or implement one or more virtual nodes 1402 that are configured to perform operations attributed to a RAN node in various methods, procedures, and/or techniques described above, including in relation to FIGS. 6-9.

Hardware 1404 includes processing circuitry, memory that stores software and/or instructions (collected denoted computer program 1404a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a-b (one or more of which may be generally referred to as VMs 1408), and/or perform any of the functions, features and/or benefits described in relation with some embodiments described herein. Virtualization layer 1406 may present a virtual operating platform that appears like networking hardware to VMs 1408.

VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1408 may be a software implementation of a physical machine that runs programs as if they were executing on a physical, non-virtualized machine. Each VM 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration function 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. Host 1502 also includes software, which is stored in or accessible by host 1502 and executable by the processing circuitry. The software includes a host application that may be operable to provide a service to a remote user, such as UE 1506 connecting via an over-the-top (OTT) connection 1550 extending between UE 1506 and host 1502. In providing the service to the remote user, a host application may provide user data which is transmitted using OTT connection 1550.

Network node 1504 includes hardware enabling it to communicate with host 1502 and UE 1506. Connection 1560 may be direct or pass through a core network (like core network 1006 of FIG. 10) and/or one or more other intermediate networks, such as one or more public, private, or hosted networks. For example, an intermediate network may be a backbone network or the Internet.

UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of host 1502. In host 1502, an executing host application may communicate with the executing client application via OTT connection 1550 terminating at UE 1506 and host 1502. In providing the service to the user, the UE's client application may receive request data from the host's host application and provide user data in response to the request data. OTT connection 1550 may transfer both the request data and the user data. The UE's client application may interact with the user to generate the user data that it provides to the host application through OTT connection 1550.

OTT connection 1550 may extend via a connection 1560 between host 1502 and network node 1504 and via a wireless connection 1570 between network node 1504 and UE 1506 to provide the connection between host 1502 and UE 1506. Connection 1560 and wireless connection 1570, over which OTT connection 1550 may be provided, have been drawn abstractly to illustrate the communication between host 1502 and UE 1506 via network node 1504, without explicit reference to any intermediary devices and the precise routing of messages via these devices.

As an example of transmitting data via OTT connection 1550, in step 1508, host 1502 provides user data, which may be performed by executing a host application. In some embodiments, the user data is associated with a particular human user interacting with UE 1506. In other embodiments, the user data is associated with a UE 1506 that shares data with host 1502 without explicit human interaction. In step 1510, host 1502 initiates a transmission carrying the user data towards UE 1506. Host 1502 may initiate the transmission responsive to a request transmitted by UE 1506. The request may be caused by human interaction with UE 1506 or by operation of the client application executing on UE 1506. The transmission may pass via network node 1504, in accordance with the teachings of the embodiments described throughout this disclosure. Accordingly, in step 1512, network node 1504 transmits to UE 1506 the user data that was carried in the transmission that host 1502 initiated, in accordance with the teachings of the embodiments described throughout this disclosure. In step 1514, UE 1506 receives the user data carried in the transmission, which may be performed by a client application executed on UE 1506 associated with the host application executed by host 1502.

In some examples, UE 1506 executes a client application which provides user data to host 1502. The user data may be provided in reaction or response to the data received from host 1502. Accordingly, in step 1516, UE 1506 may provide user data, which may be performed by executing the client application. In providing the user data, the client application may further consider user input received from the user via an input/output interface of UE 1506. Regardless of the specific manner in which the user data was provided, UE 1506 initiates, in step 1518, transmission of the user data towards host 1502 via network node 1504. In step 1520, in accordance with the teachings of the embodiments described throughout this disclosure, network node 1504 receives user data from UE 1506 and initiates transmission of the received user data towards host 1502. In step 1522, host 1502 receives the user data carried in the transmission initiated by UE 1506.

One or more of the various embodiments improve the performance of OTT services provided to UE 1506 using OTT connection 1550, in which wireless connection 1570 forms the last segment. More precisely, embodiments may enable a UE to execute an LTM cell switch procedure that includes HARQ reset but no RLC re-establishment (e.g., intra-DU) with a reduced data interruption. For example, embodiments may reduce the retransmission delay for RLC PDUs that are lost due to a HARQ reset during LTM cell switch. At a high level, embodiments may improve UE mobility in a RAN. When UEs and RANs improved in this manner are used to deliver OTT services to end users, they increase the value of the OTT services to the end users and to the OTT service providers.

In an example scenario, factory status information may be collected and analyzed by host 1502. As another example, host 1502 may process audio and video data which may have been retrieved from a UE for use in creating maps. As another example, host 1502 may collect and analyze real-time data to assist in controlling vehicle congestion (e.g., controlling traffic lights). As another example, host 1502 may store surveillance video uploaded by a UE. As another example, host 1502 may store or control access to media content such as video, audio, VR or AR which it can broadcast, multicast or unicast to UEs. As other examples, host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1550 between host 1502 and UE 1506, in response to variations in the measurement results. The measurement procedure and/or the network functionality for reconfiguring the OTT connection may be implemented in software and hardware of host 1502 and/or UE 1506. In some embodiments, sensors (not shown) may be deployed in or in association with other devices through which OTT connection 1550 passes; the sensors may participate in the measurement procedure by supplying values of the monitored quantities exemplified above, or supplying values of other physical quantities from which software may compute or estimate the monitored quantities. The reconfiguring of OTT connection 1550 may include message format, retransmission settings, preferred routing etc.; the reconfiguring need not directly alter the operation of network node 1504. Such procedures and functionalities may be known and practiced in the art. In certain embodiments, measurements may involve proprietary UE signaling that facilitates measurements of throughput, propagation times, latency and the like, by host 1502. The measurements may be implemented in that software causes messages to be transmitted, in particular empty or ‘dummy’ messages, using OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In addition, certain terms used in the present disclosure, including the specification, drawings and embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:

A1. A method for a user equipment (UE) configured to communicate with a radio access network (RAN) node, the method comprising:
receiving, via a serving cell provided by the RAN node, an RRCReconfiguration message that includes one or more L1/L2-triggered mobility (LTM) configurations associated with respective one or more candidate cells;
receiving, from the RAN node, a lower layer signalling message indicating that the UE should perform an LTM procedure from the serving cell to a first candidate cell of the one or more candidate cells;
executing the LTM procedure towards the first candidate cell, including performing a reset of a first protocol layer used for communicating with the serving cell; and
after executing the LTM procedure, initiating retransmission in the first candidate cell of protocol data units (PDUs), of a second protocol layer, that were lost or discarded due to the reset of the first protocol layer.

A2. The method of embodiment A1, wherein the first candidate cell and the serving cell are provided by a same distributed unit (DU) of the RAN node.

A3. The method of any of embodiments B1-B2, wherein one or more of the following applies: the first protocol layer is below the second protocol layer, and the lower layer signaling message is a message of the first protocol layer.

A3a. The method of any of embodiments A1-A3, wherein the first protocol layer is medium access control (MAC) and the second protocol layer is radio link control (RLC).

A3b. The method of any of embodiments A1-A3a, wherein one or more of the following applies:
the lower layer signaling message is at a protocol layer below a radio resource control (RRC) protocol layer; and
the lower layer signaling message is one of the following: MAC Control Element (MAC CE), or physical layer (PHY) Downlink Control Information (DCI).

A4. The method of any of embodiments A1-A3c, wherein performing the reset of the first protocol layer comprises one or more of the following:
setting a new data indicator (NDI) for an uplink (UL) hybrid ARQ (HARQ) process to zero;
flushing soft buffers for a downlink (DL) HARQ process; and
considering a next-received transmission of a transport block (TB) as an initial transmission for a DL HARQ process.

A5. The method of any of embodiments A1-A4, wherein the lost or discarded PDUs of the second protocol layer include uplink (UL) PDUs transmitted via the serving cell.

A5a. The method of embodiment A5, wherein:
the method further comprises receiving one or more status reports of the second protocol layer, according to one of the following: in the serving cell before executing the LTM procedure; or in the first candidate cell after executing the LTM procedure; and
initiating retransmission of the UL PDUs is responsive to the one or more status reports.

A5b. The method of embodiment A5a, wherein:
the method further comprises, after executing the LTM procedure, transmitting in the first candidate cell one or more PDUs, of the second protocol layer, that have respective polling bits that are set; and
the one or more status reports are received in the first candidate cell responsive to the one or more PDUs having respective polling bits that are set.

A5c. The method of embodiment A5, wherein initiating retransmission of the UL PDUs is responsive to the one or more of the following indications from the first protocol layer to the second protocol layer in the UE:
an indication that transmission of some PDUs of the second protocol layer has failed; an indication that one or more PDUs of the second protocol layer were discarded during reset of the first protocol layer;
an indication of sequence numbers (SN) of PDUs of the second protocol layer that were discarded during reset of the first protocol layer; and
how many PDUs of the second protocol layer were discarded during reset of the first protocol layer.

A6. The method of any of embodiments A1-A5c, wherein:
the lost or discarded PDUs of the second protocol layer include downlink (DL) PDUs transmitted via the serving cell; and
initiating retransmission of the DL PDUs comprises transmitting one or more status reports of the second protocol layer, according to one of the following:
   in the serving cell before executing the LTM procedure; or
   in the first candidate cell after executing the LTM procedure; and

A6a. The method of embodiment A6, wherein initiating retransmission of the DL PDUs further comprises stopping a timer, of the second protocol layer, that prevents transmission of status reports of the second protocol layer when running.

A6b. The method of any of embodiments A6-A6a, wherein transmitting the one or more status reports is responsive to receiving one or more of the following indications from the RAN node:
an indication to transmit the one or more status reports of the second protocol layer; and
an indication to stop a timer, of the second protocol layer, that prevents transmission of status reports of the second protocol layer when running.

A6c. The method of embodiment A6b, wherein the one or more indications are received according to one of the following:
in the serving cell before executing the LTM procedure; or in the first candidate cell after executing the LTM procedure; and

A6d. The method of any of embodiments A6b-A6c, wherein the one or more indications are included in or with one of the following:
the lower layer signalling message;
the LTM configuration associated with the first candidate cell; or one or more PDUs of the second protocol layer that were received in the serving cell or in the first candidate cell.

A6e. The method of embodiment A6d, wherein the one or more PDUs of the second protocol layer have respective polling bits that are set.

A7. The method of any of embodiments A1-A6e, further comprising, after executing the LTM procedure to the first candidate cell, sending to the RAN via the first candidate cell an indication that the UE has completed the LTM procedure.

A8. The method of any of embodiments A1-A7, wherein:
the serving cell is a primary cell (PCell) or a special cell (SpCell) of a cell group that also includes one or more secondary cells (SCells);
the first candidate cell is a PCell or an SpCell of a further cell group that also includes one or more SCells;
the LTM configuration associated with the first candidate cell also includes configurations for the SCells of the further cell group; and
executing the LTM procedure towards the first candidate cell also includes one or more of the following: releasing at least one SCell of the cell group, and adding at least one SCell of the further cell group.

B1. A method for a radio access network (RAN) node configured to provide a serving cell to user equipment (UEs), the method comprising:
sending, to a UE via the serving cell, an RRCReconfiguration message that includes one or more L1/L2-triggered mobility (LTM) configurations associated with respective one or more candidate cells;
sending, to the UE via the serving cell, a lower layer signalling message indicating that the UE should perform an LTM procedure from the serving cell to a first candidate cell of the one or more candidate cells, including UE reset of a first protocol layer used for communicating with the serving cell; and
initiating retransmission in the first candidate cell of protocol data units (PDUs), of a second protocol layer, that were lost or discarded due to the UE reset of the first protocol layer.

B2. The method of embodiment B1, wherein the serving cell and the first candidate cell are provided by a same distributed unit (DU) of the RAN node.

B3. The method of any of embodiments B1-B2, wherein one or more of the following applies: the first protocol layer is below the second protocol layer, and the lower layer signaling message is a message of the first protocol layer.

B3a. The method of any of embodiments B1-B3, wherein the first protocol layer is medium access control (MAC) and the second protocol layer is radio link control (RLC).

B3b. The method of any of embodiments B1-B3, wherein one or more of the following applies:
the lower layer signaling message is at a protocol layer below the radio resource control (RRC) protocol layer; and
the lower layer signaling message is one of the following: MAC Control Element (MAC CE), or PHY Downlink Control Information (DCI).

B4. The method of any of embodiments B1-B3, further comprising, based on sending the lower layer signaling message, performing a corresponding reset of the first protocol layer used to communicate with the UE via the serving cell, including one or more of the following:
setting a new data indicator (NDI) for a downlink (DL) hybrid ARQ (HARQ) process to zero;
flushing soft buffers for an uplink (UL) HARQ process; and considering a next-received transmission of a transport block (TB) as an initial transmission for an UL HARQ process.

B5 The method of any of embodiments B1-B4, wherein:
the lost or discarded PDUs of the second protocol layer include uplink (UL) PDUs transmitted via the serving cell;
initiating retransmission of the UL PDUs comprises sending, to the UE via the serving cell, one or more status reports of the second protocol layer; and
reception of the one or more status reports cause the UE to initiate retransmission of the UL PDUs in the first candidate cell.

B5a. The method of embodiment B5, wherein the one or more status reports are sent to the UE together with the lower layer signaling message.

B6. The method of any of embodiments B1-B5a, wherein:
the lost or discarded PDUs of the second protocol layer include downlink (DL) PDUs transmitted via the serving cell;
initiating retransmission of the DL PDUs comprises sending to the UE via the serving cell one or more of the following indications:
   an indication to transmit one or more status reports, of the second protocol layer, in the candidate target cell; and
   an indication to stop a timer, of the second protocol layer, that prevents transmission of status reports of the second protocol layer when running.

B7. The method of embodiment B6, wherein the one or more indications are included in or with one of the following:
the lower layer signalling message;
the LTM configuration associated with the first candidate cell; or
one or more PDUs of the second protocol layer that were transmitted in the serving cell before the lower layer signalling message.

B8. The method of embodiment B7, wherein the one or more PDUs of the second protocol layer have respective polling bits that are set.

C1. A method for a radio access network (RAN) node configured to provide a serving cell to user equipment (UEs), the method comprising:
receiving, from a UE, a message indicating that the UE has completed a L1/L2-triggered mobility (LTM) procedure from a source cell to a serving cell provided by the RAN node, wherein:
   the serving cell is a first candidate cell associated with an LTM configuration, and
   the LTM procedure includes UE reset of a first protocol layer used for communicating with the source cell; and
initiating retransmission in the serving cell of protocol data units (PDUs), of a second protocol layer, that were lost or discarded due to the UE reset of the first protocol layer.

C2. The method of embodiment C1, wherein the source cell and the serving cell are provided by a same distributed unit (DU) of the RAN node.

C3. The method of any of embodiments C1-C2, wherein one or more of the following applies: the first protocol layer is below the second protocol layer, and the lower layer signaling message is a message of the first protocol layer.

C3a. The method of any of embodiments C1-C3, wherein the first protocol layer is medium access control (MAC) and the second protocol layer is radio link control (RLC).

C4. The method of any of embodiments C1-C3a, further comprising, based on the message, performing a corresponding reset of the first protocol layer used to communicate with the UE via the serving cell, including one or more of the following:
setting a new data indicator (NDI) for a downlink (DL) hybrid ARQ (HARQ) process to zero;
flushing soft buffers for an uplink (UL) HARQ process; and considering a next-received transmission of a transport block (TB) as an initial transmission for an UL HARQ process.

C5. The method of any of embodiments C1-C4, wherein:
the lost or discarded PDUs of the second protocol layer include uplink (UL) PDUs transmitted via the serving cell;
initiating retransmission of the UL PDUs comprises sending, to the UE via the serving cell, one or more status reports of the second protocol layer; and
reception of the one or more status reports causes the UE to initiate retransmission of the UL PDUs in the first candidate cell.

C5a. The method of embodiment C5, wherein:
the method further comprises receiving from the UE via the serving cell one or more PDUs, of the second protocol layer, that include respective polling bits that are set; and
sending the one or more status reports to the UE is responsive to receiving the one or more PDUs having respective polling bits that are set.

C6. The method of any of embodiments C1-C5a, wherein:
the lost or discarded PDUs of the second protocol layer include downlink (DL) PDUs transmitted via the serving cell; and
initiating retransmission of the DL PDUs comprises receiving from the UE via the serving cell one or more status reports of the second protocol layer.

C7. The method of embodiment C6, wherein initiating retransmission of the DL PDUs further comprises sending to the UE via the serving cell one or more of the following indications:
an indication to transmit the one or more status reports; and
an indication to stop a timer, of the second protocol layer, that prevents transmission of status reports of the second protocol layer when running.
wherein the one or more status reports are received responsive to the one or more indications.

C8. The method of embodiment C7, wherein the one or more indications are included in or with one or more PDUs of the second protocol layer.

C9. The method of embodiment C8, wherein the one or more PDUs of the second protocol layer have respective polling bits that are set.

D1. A user equipment (UE) configured to communicate with a radio access network (RAN) node, the UE comprising:
communication interface circuitry configured to communicate with the RAN node via at least one serving cell; and
processing circuitry operably coupled to the communication interface circuitry, wherein the processing circuitry and communication interface circuitry are further configured to perform operations corresponding to any of the methods of embodiments A1-A8.

D2. A user equipment (UE) configured to communicate with a radio access network (RAN) node, the UE being further configured to perform operations corresponding to any of the methods of embodiments A1-A8.

D3. A non-transitory, computer-readable medium storing computer-executable instructions that, when executed by processing circuitry of a user equipment (UE) configured to communicate with a radio access network (RAN) node, the UE, configure the UE to perform operations corresponding to any of the methods of embodiments A1-A8.

D4. A computer program product comprising computer-executable instructions that, when executed by processing circuitry of a user equipment (UE) configured to communicate with a radio access network (RAN) node, the UE, configure the UE to perform operations corresponding to any of the methods of embodiments A1-A8.

E1. A radio access network (RAN) node configured to provide one or more serving cells to user equipment (UEs), the RAN node comprising:
communication interface circuitry configured to communicate with UEs via the one or more serving cells; and
processing circuitry operably coupled to the communication interface circuitry, whereby the processing circuitry and the communication interface circuitry are configured to perform operations corresponding to any of the methods of embodiments B1-B8.

E2. A radio access network (RAN) node configured to provide one or more serving cells to user equipment (UEs), the RAN node being further configured to perform operations corresponding to any of the methods of embodiments B1-B8.

E3. A non-transitory, computer-readable medium storing computer-executable instructions that, when executed by processing circuitry of a radio access network (RAN) node configured to provide one or more serving cells to user equipment (UEs), configure the RAN node to perform operations corresponding to any of the methods of embodiments B1-B8.

E4. A computer program product comprising computer-executable instructions that, when executed by processing circuitry of a radio access network (RAN) node configured to provide one or more serving cells to user equipment (UEs), configure the RAN node to perform operations corresponding to any of the methods of embodiments B1-B8.

F1. A radio access network (RAN) node configured to provide one or more serving cells to user equipment (UEs), the RAN node comprising:

communication interface circuitry configured to communicate with UEs via the one or more serving cells; and processing circuitry operably coupled to the communication interface circuitry, whereby the processing circuitry and the communication interface circuitry are configured to perform operations corresponding to any of the methods of embodiments C1-C9.

F2. A radio access network (RAN) node configured to provide one or more serving cells to user equipment (UEs), the RAN node being further configured to perform operations corresponding to any of the methods of embodiments C1-C9.

F3. A non-transitory, computer-readable medium storing computer-executable instructions that, when executed by processing circuitry of a radio access network (RAN) node configured to provide one or more serving cells to user equipment (UEs), configure the RAN node to perform operations corresponding to any of the methods of embodiments C1-C9.

F4. A computer program product comprising computer-executable instructions that, when executed by processing circuitry of a radio access network (RAN) node configured to provide one or more serving cells to user equipment (UEs), configure the RAN node to perform operations corresponding to any of the methods of embodiments C1-C9.

1.-45. (canceled)

46. A method for a user equipment (UE) configured to communicate with a radio access network (RAN) node, the method comprising:
receiving, from the RAN node via a serving cell, a lower layer signalling message indicating that the UE should perform an layer-1/layer-2 triggered mobility (LTM) procedure from the serving cell to a first candidate cell;
executing the LTM procedure towards the first candidate cell, including performing a reset of a first protocol layer used for communicating with the serving cell; and
after executing the LTM procedure, initiating retransmission in the first candidate cell of protocol data units (PDUs) of a second protocol layer, which were lost or discarded due to the reset of the first protocol layer.

47. The method of claim 46, wherein the first candidate cell and the serving cell are provided by one of the following: the RAN node; or a same distributed unit (DU) of the RAN node.

48. The method of claim 46, wherein one or more of the following applies: the first protocol layer is below the second protocol layer, and the lower layer signaling message is a message of the first protocol layer.

49. The method of claim 46, wherein performing the reset of the first protocol layer comprises one or more of the following:
setting a new data indicator (NDI) for an uplink (UL) hybrid ARQ (HARQ) process to zero;
flushing soft buffers for a downlink (DL) HARQ process; and
considering a next-received transmission of a transport block (TB) as an initial transmission for a DL HARQ process.

50. The method of claim 46, wherein the lost or discarded PDUs of the second protocol layer include uplink (UL) PDUs transmitted via the serving cell.

51. The method of claim 50, wherein:
the method further comprises receiving one or more status reports of the second protocol layer, according to one of the following:
in the serving cell before executing the LTM procedure; or
in the first candidate cell after executing the LTM procedure; and
initiating retransmission of the UL PDUs is responsive to the one or more status reports.

52. The method of claim 51, wherein:
the method further comprises, after executing the LTM procedure, transmitting in the first candidate cell one or more PDUs, of the second protocol layer, that have respective polling bits that are set; and
the one or more status reports are received in the first candidate cell responsive to the one or more PDUs having respective polling bits that are set.

53. The method of claim 50, wherein initiating retransmission of the UL PDUs is responsive to the one or more of the following indications from the first protocol layer to the second protocol layer in the UE:
an indication that transmission of some PDUs of the second protocol layer has failed;
an indication that one or more PDUs of the second protocol layer were discarded during reset of the first protocol layer;
an indication of sequence numbers, SN, of PDUs of the second protocol layer that were discarded during reset of the first protocol layer; and
an indication of how many PDUs of the second protocol layer were discarded during reset of the first protocol layer.

54. The method of claim 46, wherein:
the lost or discarded PDUs of the second protocol layer include downlink (DL) PDUs transmitted via the serving cell; and
initiating retransmission of the DL PDUs comprises transmitting one or more status reports of the second protocol layer, according to one of the following:
in the serving cell before executing the LTM procedure; or
in the first candidate cell after executing the LTM procedure.

55. The method of claim 54, wherein initiating retransmission of the DL PDUs further comprises stopping a timer of the second protocol layer, which when running prevents transmission of status reports of the second protocol layer.

56. The method of claim 54, wherein transmitting the one or more status reports is responsive to receiving one or more of the following indications from the RAN node:
an indication to transmit the one or more status reports of the second protocol layer; and
an indication to stop a timer of the second protocol layer, which when running prevents transmission of status reports of the second protocol layer.

57. The method of claim 46, further comprising, after executing the LTM procedure to the first candidate cell, sending to the RAN via the first candidate cell an indication that the UE has completed the LTM procedure.

58. A method for a radio access network (RAN) node configured to provide a serving cell to user equipment (UEs), the method comprising:
sending, to the UE via the serving cell, a lower layer signalling message indicating that the UE should perform an layer-1/layer-2 triggered mobility (LTM) procedure from the serving cell to a first candidate cell, including UE reset of a first protocol layer used for communicating with the serving cell; and
initiating retransmission in the first candidate cell of protocol data units (PDUs) of a second protocol layer, which were lost or discarded due to the UE reset of the first protocol layer.

59. The method of claim 58, wherein the serving cell and the first candidate cell are provided by one of the following: the RAN node, or a same distributed unit (DU) of the RAN node.

60. The method of claim 58, wherein one or more of the following applies: the first protocol layer is below the second protocol layer, and the lower layer signaling message is a message of the first protocol layer.

61. The method of claim 58, further comprising, based on sending the lower layer signaling message, performing a corresponding reset of the first protocol layer used to communicate with the UE via the serving cell, including one or more of the following:
setting a new data indicator (NDI) for a downlink (DL) hybrid ARQ (HARQ) process to zero;
flushing soft buffers for an uplink (UL) HARQ process; and
considering a next-received transmission of a transport block (TB) as an initial transmission for an UL HARQ process.

62. User equipment (UE) configured to communicate with a radio access network (RAN) node, the UE comprising:
communication interface circuitry configured to communicate with the RAN node via at least one serving cell; and
processing circuitry operably coupled to the communication interface circuitry, wherein the processing circuitry and communication interface circuitry are configured to:
receive, from the RAN node via the serving cell, a lower layer signalling message indicating that the UE should perform an layer-1/layer-2 triggered mobility (LTM) procedure from the serving cell to a first candidate cell;
execute the LTM procedure towards the first candidate cell, including performing a reset of a first protocol layer used for communicating with the serving cell; and
after executing the LTM procedure, initiate retransmission in the first candidate cell of protocol data units (PDUs) of a second protocol layer, which were lost or discarded due to the reset of the first protocol layer.

63. The UE of claim 62, wherein the processing circuitry and communication interface circuitry are further configured to perform the reset of the first protocol layer based on one or more of the following operations:
setting a new data indicator (NDI) for an uplink (UL) hybrid ARQ (HARQ) process to zero;
flushing soft buffers for a downlink (DL) HARQ process; and
considering a next-received transmission of a transport block (TB) as an initial transmission for a DL HARQ process.

64. Radio access network (RAN) node configured to provide a serving cell to user equipment (UEs), the RAN node comprising:
communication interface circuitry configured to communicate with UEs via the serving cell; and
processing circuitry operably coupled to the communication interface circuitry, wherein the processing circuitry and the communication interface circuitry are configured to:
send, to the UE via the serving cell, a lower layer signalling message indicating that the UE should perform an layer-1/layer-2 triggered mobility (LTM) procedure from the serving cell to a first candidate cell, including UE reset of a first protocol layer used for communicating with the serving cell; and
initiate retransmission in the first candidate cell of protocol data units (PDUs) of a second protocol layer, which were lost or discarded due to the UE reset of the first protocol layer.

65. The RAN node of claim 64, wherein the processing circuitry and the communication interface circuitry are further configured to, based on sending the lower layer signaling message, perform a corresponding reset of the first protocol layer used to communicate with the UE via the serving cell, including one or more of the following:
setting a new data indicator (NDI) for a downlink (DL) hybrid ARQ (HARQ) process to zero;
flushing soft buffers for an uplink (UL) HARQ process; and
considering a next-received transmission of a transport block (TB) as an initial transmission for an UL HARQ process.
